(19) United States
(12) Patent Application Publication
(10) Pub. No.: US 2020/0258338 A1
(43) Pub. Date: Aug. 13, 2020

(54) SECURE VOTING SYSTEM

(71) Applicant: United States Postal Service, Washington, DC (US)

(72) Inventors: Dhananjay Goswami, Buffalo Grove, IL (US); Angela M. Lagneaux, Annapolis, MD (US); Mohan Swaminathan Venkataraman, Cary, NC (US); Wendy Henry, Arlington, VA (US); Aashish Shrestha, Morrisville, NC (US); Stephen M. Dearing, Herndon, VA (US)

(21) Appl. No.: 16/785,354

(22) Filed: Feb. 7, 2020

Related U.S. Application Data
(60) Provisional application No. 62/803,373, filed on Feb. 8, 2019.
(60) Provisional application No. 62/803,296, filed on Feb. 8, 2019.

(51) Int. Cl. G07C 13/00; H04L 9/32

(52) U.S. Cl. CPC G07C 13/00; H04L 9/3247

(57) ABSTRACT

A voting system can use the security of blockchain and the mail to provide a reliable voting system. A registered voter receives a computer readable code in the mail and confirms identity and confirms correct ballot information in an election. The system separates voter identification and votes to ensure vote anonymity, and stores votes on a distributed ledger in a blockchain.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional application Nos. 62/803,373 and 62/803,296, the entire contents of which are hereby incorporated by reference.

### BACKGROUND

### Field

This development relates to a voting system that also incorporates the use of cryptographic elements, such as blockchains, as are used with cryptographic currencies, to track and secure the vote by mail system.

### Description of the Related Art

Voters generally wish to be able to vote for elected officials or on other issues in a manner that is convenient and secure. Further, those holding elections wish to be able to ensure that election results have not been tampered with and that the results actually correspond to the votes that were cast. In some embodiments, a blockchain allows the tracking of the various types of necessary data in a way that is secure and allows others to easily confirm that data has not been altered.

### SUMMARY

In one aspect described herein, a voting system comprises a blockchain access layer configured to: receive input from a user operated mobile computing device, the input comprising a computer readable code scanned from a physical ballot, ballot selections, and an electronic signature; and receive input from an election official system, the input comprising a ballot and an election identifier; a first database in communication with the block chain access layer, the first database configured to receive and store the ballot selections and the electronic signature from the blockchain access layer; a second database in communication with the block chain access layer, the second database configured to: receive a vote identification from the blockchain access layer, the vote identification generated by the blockchain access layer in response to receive the ballot selections and electronic signature from the mobile computing device; store a first pointer to a location of the ballot selections in the first database; and store a second pointer to a location of the electronic signature in the first database; and a blockchain database configured to receive the vote identification from the second database and to receive the ballot selections from the blockchain access layer, wherein the block chain database receives the vote identification and the ballot selections when the block chain access layer receives an electronic signature confirmation from the election official system.

In some embodiments, the ballot selections and the electronic signatures are stored in separate structures in the first database.

In some embodiments, the first database has no referential data associating the ballot selections with the electronic signatures stored in the separate structures in the first database.

In some embodiments, the vote identification is a random alphanumeric string for tracking the instance of a vote.

In some embodiments, the electronic signature is an object bitmap created within a voting application on the user operated mobile computing device.

In some embodiments, the election identifier identifies a particular election.

In some embodiments, the blockchain access layer is further configured to receive a voter identification from the user operated mobile computing device, the voter identification identifying a unique user registered with the election official system.

In some embodiments, the system further comprises a verification contract database, and wherein the blockchain access layer comprises a verification service module, wherein the verification service module is configured generate a hash of the ballot selections and the electronic signature received in the blockchain access layer, and to send the hash of the ballot selections and the electronic signature to the verification contract database.

In some embodiments, the blockchain access layer is further configured to send the hash of the ballot selections and the electronic signature to the user operated mobile computing device or to the election official system.

In some embodiments, the computer readable code includes at least one of a ballot identifier, an election identifier, and a voter identifier, and wherein the blockchain access layer authorizes the mobile computing device access to an electronic ballot based on the ballot identifier, election identifier, or the voter identifier.

In another aspect, a voting method comprises receiving, in a blockchain access layer, input from a user operated mobile computing device, the input comprising a computer readable code scanned from a physical ballot, ballot selections, and an electronic signature; receiving input from an election official system, the input comprising a ballot and an election identifier; receiving, in a first database, the ballot selections and the electronic signature from the blockchain access layer; receiving, in a second database, a vote identification from the blockchain access layer, the vote identification generated by the blockchain access layer in response to receiving the ballot selections and electronic signature from the mobile computing device; storing, in the second database, a first pointer pointing to a location of the ballot selections in the first database; storing, in the second database, a second pointer pointing to a location of the electronic signature in the first database; and receiving, from the election official system, confirmation of the electronic signature; transmitting, to a blockchain database, the vote identification from the second database and the ballot selections corresponding to the vote identification based on the first pointer; and storing, in the blockchain database, the ballot selections.

In some embodiments, storing the ballot selections and the electronic signatures in the first database comprises storing the ballot selections and the electronic signature in separate structures in the first database.

In some embodiments, the first database has no referential data associating the ballot selections with the electronic signatures stored in the separate structures in the first database.

In some embodiments, the vote identification is a random alphanumeric string for tracking an instance of the ballot selection.

In some embodiments, the electronic signature is an object bitmap created within a voting application on the user operated mobile computing device.

In some embodiments, the election identifier identifies a particular election.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with the additional specificity and detail through use of the accompanying drawings.

FIG. 1 shows an exemplary system architecture for a blockchain management portion of a vote by mail system.

FIG. 2 displays an object model that demonstrates interaction between various software objects in the blockchain powered vote by mail system

FIG. 3 shows a software hierarchy diagram for various ways different users can interact with the blockchain access layer.

FIG. 4 is a software hierarchy diagram of various software modules that can be used by the blockchain access layer.

FIGS. 5a-5g display various screens of one embodiment of a voting application, user interface, or web site.

FIG. 6 depicts a message flow diagram of an embodiment of voter registration.

FIG. 7 depicts a message flow diagram of an embodiment of a log in process.

FIG. 8 depicts a message flow diagram of an embodiment of a process of providing an ballot.

FIG. 9 depicts a message flow diagram of an embodiment of a process for registering for an election.

FIG. 10 depicts a message flow diagram of an embodiment of a process for mailing ballots.

FIG. 11 depicts a message flow diagram of an embodiment of a process of receiving and submitting a mailed ballot.

FIG. 12 depicts a message flow diagram of an embodiment of a process creating an election template.

FIG. 13 depicts a message flow diagram of an embodiment of a process for creating a ballot template.

FIG. 14 displays an embodiment for a system for storing voter choices on a secure blockchain.

FIG. 15 displays an embodiment of a system that can be used to verify data sent out of the secure voting system using a verification smart contract.

FIG. 16 displays a flow chart demonstrating an embodiment of how a user can create an account to use the secure voting system.

FIG. 17 displays a flow chart demonstrating an embodiment of how an election official can load a list of voters that can use the system.

FIG. 18 displays a flow chart demonstrating an embodiment of how a user can log in to an account to use the secure voting system.

FIG. 19 displays a flow chart demonstrating an embodiment of how a election official could create a new election for use with the secure voting system.

FIG. 20 displays a flow chart demonstrating an embodiment of how a ballot can be presented to the voter and then cast by the voter using the secure voting system.

FIG. 21 displays a flow chart demonstrating an embodiment of how the votes can be tabulated using the secure voting system

### DETAILED DESCRIPTION

Secure voting is a desirable attribute of voting and election systems. Often a voter is not able to or does not desire to go to a polling place to cast a vote. An election official in a jurisdiction may wish to send secure ballots via the mail. Or, a jurisdiction may opt to utilize electronic resources for voting. In such cases, a secure voting system is desired. The security of a voting system can be increased by using the dependability and security of the United States Postal Service or similar entity, and this can be incorporated with a secure computer system using a blockchain or distributed ledger to ensure vote security and to prevent tampering or modification of electronic voting results.

In some embodiments a vote by mail system can be secured, for example, using a blockchain to record some data regarding the mailed in votes in order to demonstrate the accuracy of the election. In some embodiments, the system also allows voters to vote using scanned versions of ballots received by mail. Further, in some embodiments, the system coordinates the mailing of ballots that can then be used with the system.

In some embodiments of the vote by mail system, an election official can create a template ballot for use by potential voters. Voters can then apply to the system to allow them to receive a mailed ballot. The system can verify the identity of the voter and create a pseudo-anonymous token in the form of a unique identifier that represents the voter. In some embodiments, the vote by mail system then generates a paper ballot that is printed with a QR code, barcode, or other computer or machine readable identifier that represents the token. In some embodiments, the machine-readable identifier is a United States Postal Service Electronic Postmark (EPM®), or is a code or identifier associated with an EPM®. The paper ballot having the identifier thereon can then be mailed to the voter that corresponds to that token.

In some embodiments, the voter can receive the paper ballot and use a mobile device or other computer to scan the ballot with a camera. The voter can then use the mobile device to cast digital votes, which are then written to a blockchain. The voter can then mail the blank ballot back to the registrar. In some embodiments, the voter does not vote electronically, but instead fills out the paper ballot and sends it to the registrar. In some embodiments, the QR code, barcode, or other computer or machine readable identifier on the printed out ballot can be used to verify the that the ballot was properly submitted by a registered voter.

In some embodiments, the registrar can receive the ballot, scan the ballot's QR code, barcode, or other code, certify that the voter has voted and then ensure that the digital votes are added to the vote tallies of the candidates for election on the ballot. In other embodiments, the registrar can receive the completed ballot, and then either scan in or otherwise convert the votes on the paper ballot into digital votes, add those votes to the blockchain, certify the voter has voted, and ensure that the digital votes are added to the vote tallies of the candidates for election on the ballot.

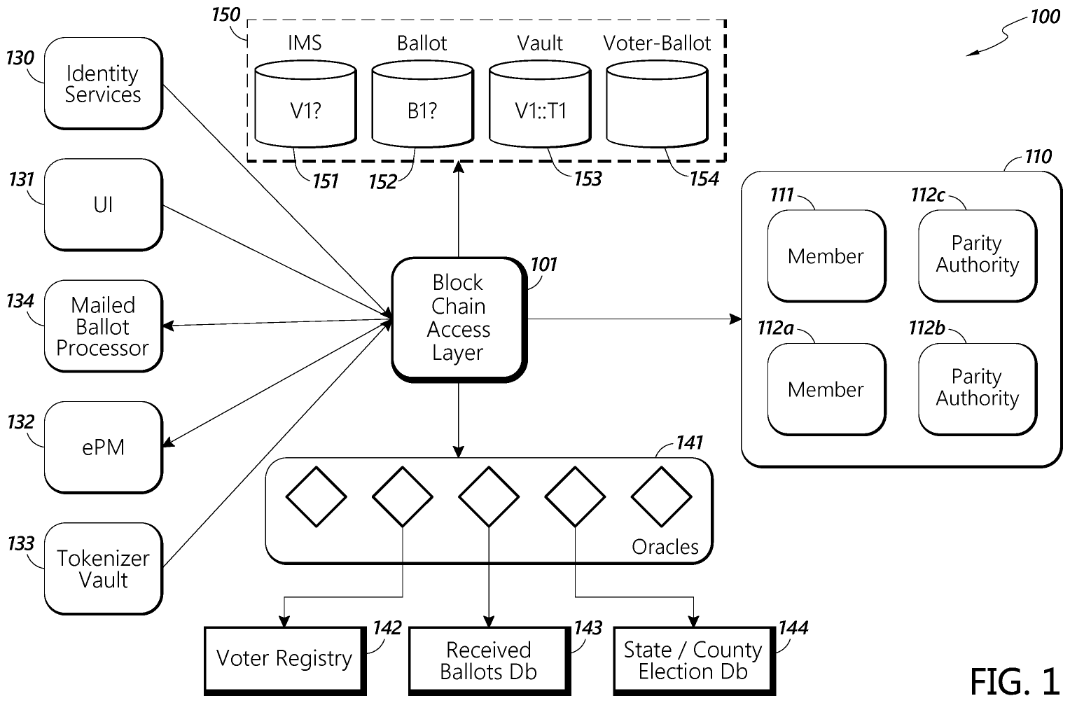

FIG. 1 depicts exemplary system architecture for a blockchain management portion of a blockchain powered vote by mail system. The exemplary system architecture 100 contains a blockchain access layer 101. Blockchain access layer 101 provides access to a blockchain (not shown) for the various system architecture components. It also can coordinate all of the non-blockchain related functions of the system. In some embodiments, the blockchain access layer 101 can comprise numerous servers running separate blockchain access layer software with a load balancer balancing the demand between the servers. In some embodiments, the blockchain is a digital ledger in which state changes are recorded. In some embodiments, the accuracy of the blockchain is ensured through the use of cryptographic functions such that previous entries in the ledger cannot not be altered without the alteration of all subsequent parts of the ledger. In some embodiments, the blockchain is separated into “blocks” of data, wherein each block contains a hash of the data of the previous block. In some embodiments, the blockchain is separated into different blocks based upon the number of entries on the digital ledger or on the amount of data stored in the digital letter. For example, each block could contain 10, 100, 1,000 or 1,000,000 ledger entries or other number of entries. Each block could also contain 10, 100, 1,000 or 1,000,000 Mb of data, or other amount of data.

In some embodiments, the blockchain can be used to defeat fraud because cryptographic functions which ensure the accuracy of the blockchain prevent bad actors from altering the blockchain. In some embodiments, the blockchain can also be used by voters, election officials, auditors, or other authorized interested parties, to check to make sure their votes were received and counted because the blockchain provides an easily accessible and robust method of recording voting actions in an unalterable way.

The embodiments of the data stored on the blockchain in the exemplary system architecture are discussed further below. In some embodiments, the blockchain is based on the Ethereum open software platform or other similar platforms. In some embodiments, the platform is a Turing complete blockchain protocol. In some embodiments, the blockchain access layer uses software “contracts” that write data to the blockchain when certain conditions are met. In some embodiments, the “contracts” can be used to develop software objects such as those further described below.

In some embodiments, blockchain access layer 101 is in wired or wireless communications with entities 110 that can interact with the blockchain directly. In some embodiments the entities 110 communicate with the blockchain access layer through a software API (not shown). In some embodiments, this can be REST-API. In some embodiments, the entities comprise a member 111 that can act as a committer on the blockchain. A committer can add validated transactions to the blockchain, thereby writing data to the ledger. In some embodiments, the member 111 can comprise numerous servers running separate member software with a load balancer balancing the demand between the servers. The ledgers can be distributed among member nodes and parity nodes. The nodes can be maintained by various election precincts or districts or election systems. In some embodiments, the blockchain ledger is not publicly distributed, but is distributed among election authorities for a county, state, country, or any combination thereof

In some embodiments, the entities also include parity authorities 112a-c. Parity authorities 112a-c act as validators for the transactions entered onto the block, ensuring that the transactions accurately reflect what happened. In some embodiments, the parity authorities 112a-c can be used as part of a consensus mechanism known as Proof of Authority (PoA). Instead of using miners to validate and create blocks on the blockchain, PoA relies on a group of nodes referred to as authority nodes or validators contained within the parity authorities. Using a round-robin structure, each authority node gets a time slot per round in which it can create and sign one new block. In case a validator is offline or not responding, it will be skipped. The validator signing a block is called the primary. In some embodiments, at least five authority nodes will be allocated among the parity authorities. In some embodiments, each parity authority can have more than one node. In some embodiments, load balancer can be used to balance the load on the various parity authorities acting as validators.

In some embodiments, blockchain access layer 101 is also in communication with identity services 130. In some embodiments, identity services 130 can communicate with the blockchain access layer 101 through a software API. In some embodiments, this can be REST-API.

Identity services 130 allow the system to confirm voter identity, and to ensure the voters are registered with the system, and to ensure the voters get the correct ballot for the precinct, jurisdiction, municipality, or other government or political division in which the voter is located. In some embodiments, the voters enter credentials, identity proofing documents, and other required documentation into the system through user interface 131.

In some embodiments, the blockchain access layer 101 can be in communication with a user interface 131. In some embodiments, the blockchain access layer 101 can communicate with the user interface 131 through an internet or other software protocol. In some embodiments, this can by Hyper Text Transfer Protocol or Hyper Text Transfer Protocol Secure. The user interface 131 allows the various users of the system, also called participants, to interact with the system. In some embodiments, there are three types of participants who can interact with the system: voters, election registrars, and notaries. Each of these types of users can interact with the system in different ways through the user interface, as described further below.

Identity services 130 then submits these proofs provided through user interface 131 to various authorities to ensure that the person's identity is confirmed. In some embodiments, these authorities could be the FBI, Equifax, the Social Security Administration, a state department of motor vehicles, or another agency that confirm identities. The identity services 130 can then generate a unique voter ID and a public/private key pair for each voter, store them appropriately, and notify the voter. In some embodiments, the identity services 130 can store the various data in a JSON data structure.

In some embodiments, the blockchain access layer 101 is in communication with electronic postmark® (ePM) system 132. In some embodiments, ePM system 132 operates in the manner describe in U.S. Patent Application No. 62/133,173, filed on Mar. 13, 2015, and U.S. application Ser. No. 15/066,945, both of which are hereby incorporated by reference in their entirety. In some embodiments, the ePM system 132 can be used to generate and verify barcodes or other computer or machine readable identifier attached to physical ballots that are sent out to allow users to vote by mail. In some embodiments, these barcodes or other computer or machine readable identifier can then be used to electronically submit votes in elections and to certify that voters submitted their results.

In some embodiments, the blockchain access layer 101 is in communication with a tokenizer vault 133. Tokenizer vault 133 tokenizes an individual ballot cast by a voter. In order to cast a vote in the digital system the voter must be assigned a token corresponding to the election by the tokenizer vault 133. In some embodiments, the token can also correspond to a particular EPM® associated with a voter. This enables the submission of a physical ballot by mail in an anonymous manner and the simultaneous creation of a digitized version using blockchain technology for added security.

In some embodiments, tokenizer vault 133 can issue multiple tokens that perform these functions. For example, the tokenizer vault 133 can issue separate ballot and obfuscation tokens. In some embodiments, a ballot token is a unique identifier that is generated for a specific user who signs up for voting in absentia in a specific election and is printed on the mailed ballot. This token authorizes the voter to one ballot submission for that election.

In some embodiments, the tokenizer vault 133 can also issue pseudo-anonymous obfuscation tokens to voters. In some embodiments, in order to cast a vote in the digital system, the voter must be assigned an obfuscation token corresponding to the election by the tokenizer vault 133. In some embodiments, the obfuscation token is issued using an acceptable algorithm to represent an anonymized ID of the voter that is securely stored by a Key Management Service/Key Vault. All user transactions are subsequently anonymized and recorded on the blockchain using the token. The obfuscation token can be a type of a Zero Knowledge Proof identifier. In some embodiments, the obfuscation token can also correspond to a particular EPM® associated with a voter.

In some embodiments, the blockchain access layer 101 is in communication with a mailed ballot processor 134. In some embodiments, the mailed ballot processor 134 can be used to analyze and identify ballots received by mail. In some embodiments, mail ballot processor 134 can read barcodes or other computer or machine-readable identifiers attached to physical ballots that are sent out to allow users to vote by mail and determine information about the received ballot. For example, the mailed ballot processor 134 can determine if a mailed ballot was received in time for the votes to count in the election based on the time that the machine-readable identifier was scanned by a mail processing system. In some embodiments, the mail ballot processor 134 can also be used to determine which entity should count a particular received ballot or to which entity, location, or facility the mailed ballot should be returned. For example, some elections may require that the ballots be counted by a local state or county authority. In some embodiments, the mail ballot processor 134 can determine the appropriate entity based on the machine-readable identifier. For example, the mail ballot processor 134 can determine the address of the voter based on the machine readable identifier and then determine that votes from that address should be sent to be counted at a particular county or state office. The mail ballot processor could then direct the mailed in ballot to be sent on to the appropriate office.

Item processing equipment, such as mail processing equipment can scan the physical documents, such as the ballots, ballet access token documents, and the like as they are moved through the distribution network. The distribution network can prove the tracking information to the system 100 to track the location of ballot and ballot related documents, to confirm delivery of the documents, and/or to provide predictive arrival dates and times. In some embodiments, the distribution network resources, such as carriers, can scan codes on the ballots as they are delivered in order to provide a positive delivery scan for the ballots or other election or voting documents to the system 100.

In some embodiments, the blockchain access layer 101 can be in communication with oracles 141. In some embodiments, oracles 141 are software services responsible for communicating and interfacing with systems outside of the blockchain powered voting system and then input information from those systems into the blockchain access layer. In some embodiments, oracles 141 can communicate with blockchain access layer 101 through a software API. In some embodiments, this API can be REST-API or RabbitMQ. In some embodiments, the oracles 141 can communicate with various state level election systems. For example, oracles 141 can interact with a voter registry 142. Voter registry 142 can be a database that contains all of the voters that are registered to vote in that state. In some embodiments, oracles 141 can interact with a received ballots database 143. In some embodiments, this database contains information on all of the voting ballots received by the state. In some embodiments, this information can then be transferred into and stored in voter-ballot database 154, as discussed below. Oracles 141 can also interact with a jurisdiction election database 144. Jurisdiction election database 144 contains all the information on what elections are happening in the jurisdiction. In some embodiments, this includes what positions are up for election and who the candidates are for each position.

In some embodiments, the blockchain access layer 101 is in communication with databases 150. In some embodiments, databases 150 can store the various information that is received by the blockchain access layer 101. In some embodiments, the databases 150 can contain all of the information that is not contained on the blockchain itself. In some embodiments, databases 150 are maintained and hosted by a single entity, such as the United States Postal Service. In some embodiments, databases 150 can contain an identity management services database 151. In some embodiments, identity management services database 151 can contain all of the information on the voters that is received by blockchain access layer 101, both from the voters directly through user interface 131, and through identity services 130.

In some embodiments, databases 150 can contain a ballot database 152. The ballot database 152 can contain all the information on a generic, or template, ballot that is received by the blockchain access layer 101. For example, the database can contain information on specific ballot templates that show the various categories and sub-categories of the open positions and the candidates (including their affiliation) who are running for those positions, and any “ballot measures” seeking citizen referendum. These can be stored and/or accessed on a jurisdictional basis, such as according to geographic division, governmental division, election, and the like.

In some embodiments, databases 150 can contain a vault database 153. The vault database 153 is a secure database that maintains the correspondence between voters and the tokens that are assigned to the voters. In some embodiments, the vault can store an alphanumeric voterID for each voter, and store an association between the voterID and an alphanumeric electionID that identifies a particular election and a token that indicates that the voter can vote in that election. In some embodiments, the vault database 153 can also store an electronic postmark® (ePM®) that corresponds to individual voters.

In some embodiments, databases 150 can also contain a voter-ballot database 154. The voter-ballot database 154 stores the electronic completed ballots submitted by the voters. In some embodiments, the voter-ballot database 154 can also contain ballots submitted by voters, either via electronic voting through a mobile app or website as described further below, through a mailed ballot, or from a voting machine at a polling place. In some embodiments, the record of votes includes information gathered by a particular state or county's database. In some embodiments, the voter-ballot database 154 can determine or store information regarding whether if a particular voter has voted more than once based on the identifier received with each ballot or which is associated with each ballot. For example, the voter-ballot database can determine that a particular voter voted both at polling place by receiving a voting identifier from a voting machine at a polling place and by the identifier received a mail-in ballot. The voting can remain anonymous, and only the comparison or match between identifiers will be noted.

In some embodiments, if the voter-ballot database 154 detects multiple votes, or identifies a match between an identifier from a voting machine at a polling place and an identifier on a mail-in ballot, it can take certain actions. For example, it could flag the voter or ballot for review for fraud or it could prioritize certain types of votes over others. For example, the voter-ballot database 154 may prioritize the polling place vote over a mailed-in ballot or a voting app vote. If there is a match between an identifier from a voting machine and an identifier on a mail-in ballot, or if there is a record of multiple votes from one voter, the mail-in ballot may be discarded. In some embodiments, when this situation is detected, the vote from the voting machine may be discarded in favor of the mail-in ballot. In some embodiments, all voter information can be discarded if there is a conflict between voting for a particular voter or if there are multiple ballots filled out by one voter.

In some embodiments, the various aspects of the system architecture described in FIG. 1 can operate on or be a component of a processing system implemented with one or more processors. The system architecture may operate on a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The processors may comprise, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processor or processors typically has conventional address lines, conventional data lines, and one or more conventional control lines. The processor or processors may be in communication with a processor memory, which may include, for example, RAM memory, flash memory, ROM memory, EPROM memory, EEPROM memory, registers, hard disk, a removable disk, a CD-ROM, or any other form of storage medium known in the art. The processor memory may include, for example, software, at least one software module, instructions, steps of an algorithm, or any other information. In some embodiments, the processor or processors performs processes in accordance with instructions stored in the processor memory. These processes may include, for example, controlling features and/or components of the blockchain powered vote by mail system architecture 100, and controlling access to and from, and transmitting information and data to and from the blockchain powered vote by mail system architecture and the constituent components of the blockchain powered vote by mail system architecture 100, as described herein.

The processor or processors that are running vote by mail system architecture can also be in communication with system memory, configured to store information, such as confidence data, item-carrier information, expected deliveries data and the like. The system memory may comprise a database, a comma delimited file, a text file, or the like.

In some embodiments, the processor or processors is/are connected to a communication feature. The communication feature is configured for wired and/or wireless communication. In some embodiments, the communication feature communicates via telephone, cable, fiber-optic, or any other wired communication network. In some embodiments, the communication feature may communicate via cellular networks, WLAN networks, or any other wireless network. The communication feature is configured to receive instructions and to transmit and receive information among components of the vote by mail system architecture and, in some embodiments, with a central server (not shown) or other resource outside the vote by mail system architecture, as desired.

In some embodiments, the components of the vote by mail system architecture 100 can operate on a virtual processor and a virtual memory in a cloud based system.

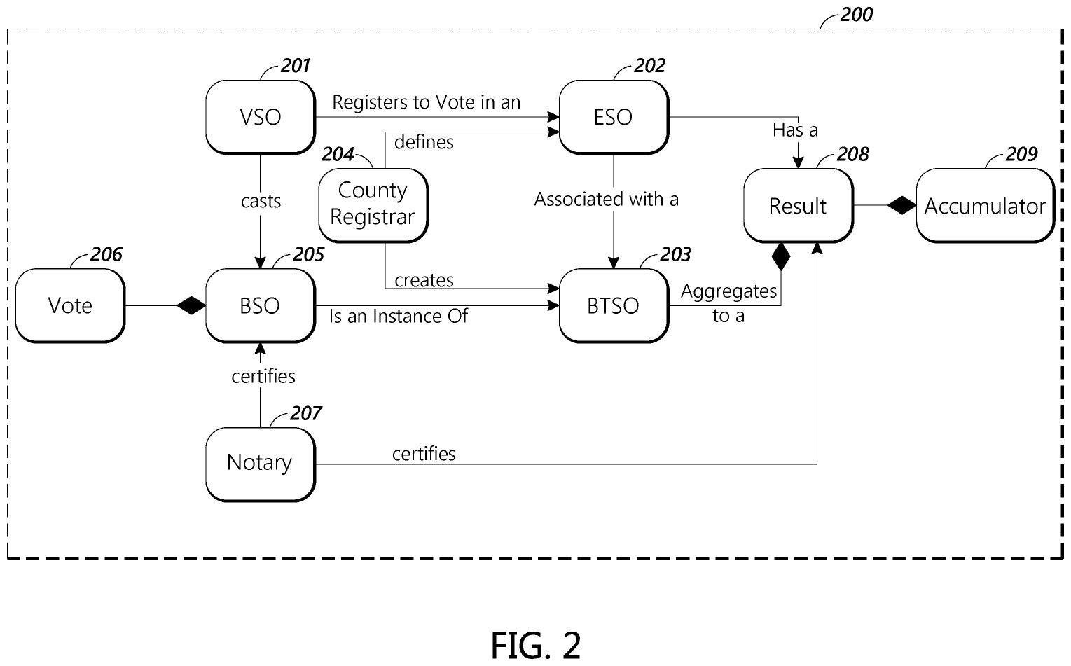

FIG. 2 displays an object model that demonstrates the interaction between various software objects in a voting software system 200. In some embodiments, one software object is a voter 201 (“VSO 201”). VSO 201 is a software object representing any individual who is a US citizen over the age of 18 and meets the state's residency requirements and/or other voting requirements. In some embodiments, a specific VSO 201 stores data about a specific voter. For example, the VSO 201 can store a voter digital id, a voter name, a voter jurisdiction, a voter permanent mailing address, voter current address, voter verification number, and other voter details. In some embodiments, the VSO 201 also contains voter identification information, such as a voter digital ID, assigned by identity services 130, a voter public key and private key, assigned by identity services 130, and a token to vote assigned by tokenizer vault 133.

In some embodiments, the voting software system 200 can register VSO 201 to vote in an election software object 202 (“ESO 202”). An ESO 202 is a definition of the basic attributes of the process for filling open positions for “Public Office” in the federal, state, county or municipality, or determining the course of action to be taken on public policy issues through a voter referendum, ballot measure, and the like. In some embodiments, the ESO 202 can contain information on a specific election such as, an alpha-numeric election ID, a description of the election, the state and county the election is taking place in, the various candidates, positions, and public referendums on the federal, state, county, local, and municipal positions and issues to be voted on, the date of the election and the status of the election.

In some embodiments, voting software system 200 can associate ESO 202 with a ballot template software object 203 (BTSO 203). In some embodiments, BTSO 203 elaborates the details of an election. For example BTSO 203 can be a State/County specific template showing the various categories and sub-categories of the open positions and the candidates (including their affiliation) who are running for those positions, and any “ballot measures” seeking citizen referendum. In some embodiments, a unique identifier is assigned to each ballot based on the election and the voter receiving the ballot and is then used to mail that ballot to a voter.

In some embodiments, voting software system 200 uses county registrar software object 204 (CRSO 204) to define an election and create a ballot template. In some embodiments, CRSO 204 helps to define the elections and create the ballot. CRSO 204 varies by what state the blockchain powered vote by mail system is implemented in. In some embodiments, the CRSO 204 can help the actual physical county registrar certify the official lists of candidates running for state offices, advise candidates and local elections officials on the qualifications and requirements for running for office, provide guidance on how candidates can select acceptable candidate ballot designations, determine the order in which candidates are placed on the ballot, track and certify ballot initiatives, coordinate the tabulation of the votes from each county on election night, and use its voter registration and outreach team to produce voter registration forms, voter information publications, and encourage people to register and vote.

In some embodiments, voting software system 200 can receive input from an actual voter and can then “cast” or create ballot software object 205 (BSO 205), which is a specific instance of BTSO 203. BSO 205 is completed ballot template 203 and is associated with the VSO 201 of the voter that provided the input that was used to fill out BSO 205. In some embodiments, BSO 205 contains a collection of vote software objects 206, which represent the actual votes cast by the voter that corresponds to a specific VSO 201.

In some embodiments, the voting software system 200 can use notary software object 207 (NSO 207) to certify that BSO 205 was correctly cast. In some embodiments, the NSO 207 certifies that BSO 205 was correctly cast by verifying a hash provided with the BSO 205 with its own computation.

In some embodiments, the NSO 207 will also certify results software object 208 (RSO 208), which is an aggregate of all of the casted votes and represents the result of the election. In some embodiments, the NSO 207 similarly certifies RSO 208 by verifying a hash provided with the RSO 208 with its own computation. RSO 208 is calculated by the voting software system 200 using the accumulator software object 209 (ASO 209). ASO 209 appropriately buckets each vote received to the receiving candidate. ASO ensures each vote that is recorded is counted properly and can summarize the votes received by various categories.

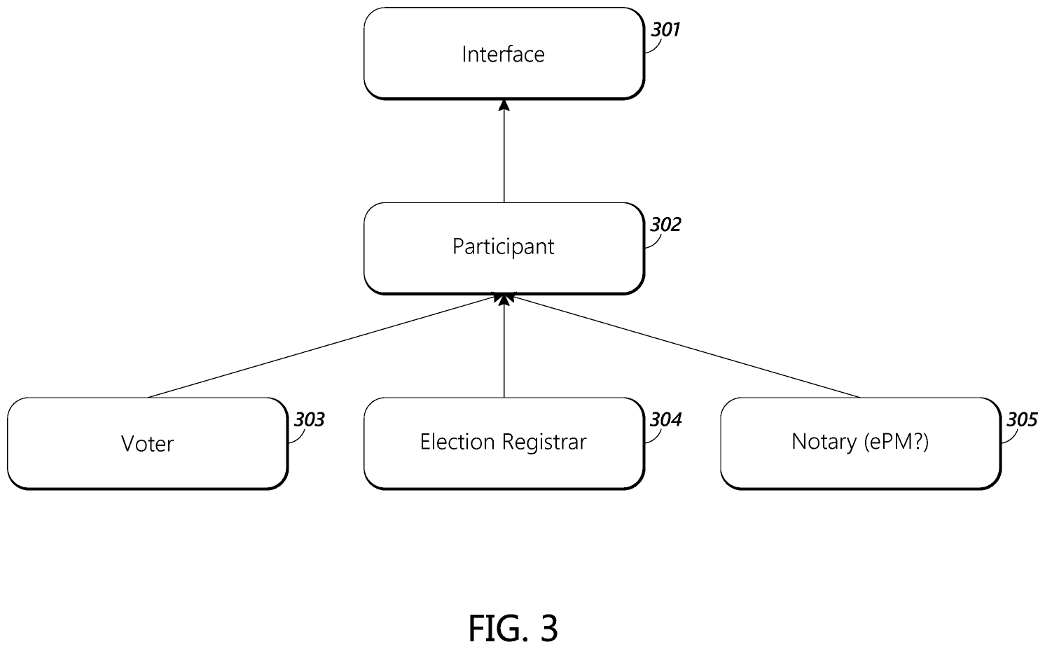

FIG. 3 shows a software hierarchy diagram for the various ways different users can interact with the blockchain access layer 101 through user interface 131. In some embodiments, different users have access to different functions that they can use to perform actions through blockchain access layer 101. At the highest level, all types of users can interact with blockchain access layer 101 through the functions contained through an interface 301 software object. In some embodiments, interface 301 is a software object contained within user interface 131 and/or utilize user interface 131. Interface 301 allows users to access basic blockchain functions. For example, interface 301 allows all users to verify the connection to the blockchain, instantiate an API that allows control of the blockchain access layer 101 and also allows the users to interact with databases 150. In some embodiments, this interface can be a BaseWeb3 type interface.

The next hierarchical level is a participant 302 software object. Participant 302 is a software object that interacts with interface 301 to allow users to perform functions common to all users. In some embodiments, participants can use the interface 301 to create an account on the blockchain access layer 101, create a user on the blockchain access layer 101, generate a public and private key pair for the user that is used for signing transactions entered onto the blockchain, login to the system, and sign specific transactions. Participants can also come in three categories: voters, registrars, and notaries. Each category can perform additional specific functions for that particular category of participants.

For example, some participants are voters 303. In some embodiments, voters can register to vote through the system (e.g. request receive an ballot), register for a digital voter ID, cast a digital ballot, scan a token, review their own voting status, and view the electronic ballot that they previously cast. In some embodiments, the voters 303 can view the electronic ballots they previously cast by using the token associated with their ballots by accessing their ballot in voter-ballot database 154 through blockchain access layer 101 and user interface 131. In some embodiments, the voters 303 can also use the user interface to track the progress of physical ballots as it traverses the mail system from both the election office and its return to the election office.

In some embodiments, participants 302 can also be election registrars 304. In some embodiments, election registrars 304 can register their election on the blockchain and define the election, including what date and time, what positions are open, who is running for those elections, and what ballot measures are on the ballot. Election registrars 304 can also create a template ballot for the election and view the voter status for each voter (e.g. who has voted or what they have voted on). In some embodiments, the registrars can access a list of which voters voted via the blockchain without accessing the actual votes the voters cast.

In some embodiments, participants 302 can also include notaries 305. Notaries 305 can certify that the results of an election once all of the ballots have been cast. In some embodiments, the notaries 305 can certify the results of individual ballots through the use of the ePM® system 132. Once all of the ballots have been certified, Notaries 305 can then certify the results of the entire election.

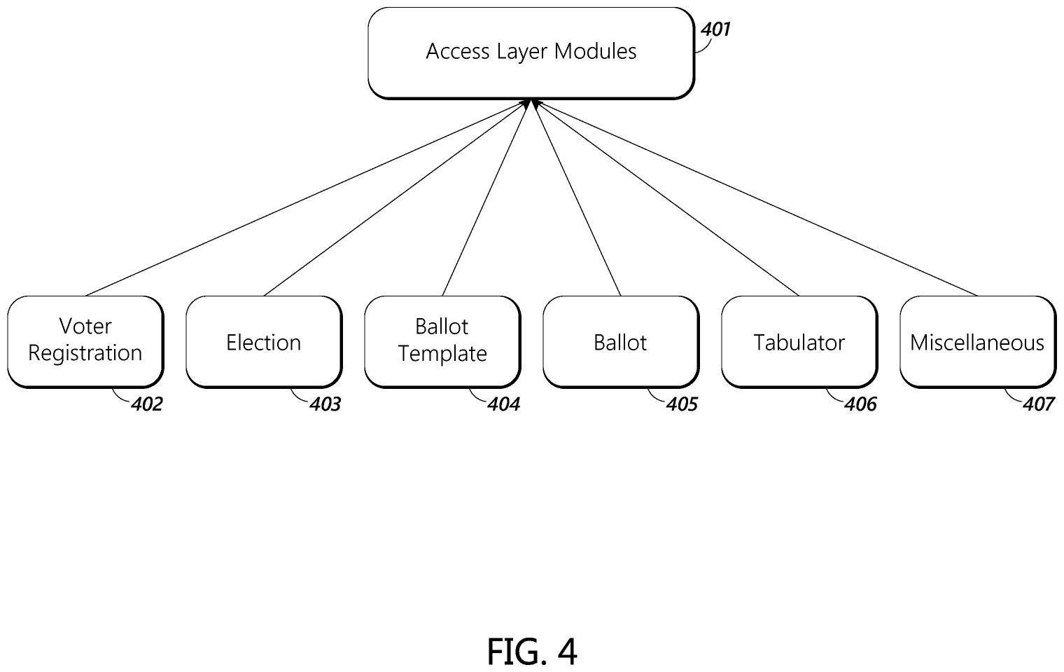

FIG. 4 is a software hierarchy diagram of the various software modules that can be used by the blockchain access layer 101. Access layer modules 401 comprises numerous software modules that are used by blockchain access layer 101 to perform various functions, as described below. In some embodiments, the software modules can take the form of Ethereum contracts in an Ethereum network. In some embodiments, one of the access layer modules 401 is a voter registration software module 402. Voter registration software module 402 can perform various functions such as registering a voter 303 to vote in the system (e.g. registering a voter as receiving a ballot) and verifying a voter's identity. In some embodiments, the voter registration software module 402 can use identity services 130 and the identity management services database 151 in databases 150. In some embodiments, voter registration software module 402 can also query for the voter's address and query for the voter's ballot.

In some embodiments, access layer modules 401 can also comprise an election software module 403. Election software module 403 can be used to register an election with the system. In some embodiments, for example, election software module 403 can register elections that are happening in the state/county. In some embodiments, this includes what positions are up for election and who the candidates are for each position. In some embodiments, election software module 403 can also be used to query for previously registered elections.

In some embodiments, one of the access layer modules 401 is a ballot template software module 404. In some embodiments, ballot template software module 304 can be used to create ballot templates 203. In some embodiments, the created ballot templates 203 can be stored in the state/county election database 144 or in the ballot database 152. Ballot templates 203 are generic ballots that elaborate the details of an election. The ballot template can be a state/county specific template showing the various categories and sub-categories of the open positions and the candidates (including their affiliation) who are running for those positions, and any “ballot measures” seeking citizen referendum. In some embodiments, ballot template software module 404 can also query for and get a ballot template 203 from either ballot 152 or state/county election database 144, record the address for all of the candidates on the ballot, and then query for and get the various candidate addresses from state/county election database 144.

In some embodiments, another of the access layer modules 401 can be a ballot software module 405. Ballot software module 405 can be used to receive the ballots that are completed by voters. The ballot software module 405 can then be used to process the votes on the ballot.

In some embodiments, one of the access layer modules 401 can be a tabulator software module 406. In some embodiments, tabulator software module 406 appropriately buckets each vote received to the receiving candidate. The tabulator software module 406 ensures each vote that is recorded is counted properly and can summarize the votes received by various categories. In some embodiments, tabulator software module 406 can be used to record all of the votes from all of the received ballots and the get a total count of the vote for each candidate.

In some embodiments, another of access layer modules 401 can be a miscellaneous software module 407. In some embodiments, miscellaneous software module 407 can be used to perform functions to verify the blockchain. For example, miscellaneous software module 407 can be used to verify the hash of the various blocks on the blockchain and verify the signatures on the transactions of the blockchain ledger.

As described above, the numerous software operations performed by the blockchain powered vote by mail software rely on numerous types of data to be stored in the system. As explained above, in some embodiments, this data is stored in the various databases 150. In some embodiments, a portion of this data is stored directly on the blockchain itself. In some embodiments, it is advantageous to store limited information on the blockchain so that the blockchain can be used to confirm the validity of the election, while preventing others from determining exactly who voted for who in the election. Table 1 shows examples of what can be stored on and off the blockchain for the various software modules and objects discussed above. In some embodiments, off blockchain access is stored either in databases 150 or in voter registry database 142, received ballots database 143, or state/county election database 144.

TABLE 1

| Software Object Or Module | Off Chain | On Chain |
|---|---|---|
| Ballot Template 404 | Ballot ID | Ballot Template ID |
| | Election ID | ElectionID |
| | State | State |
| | County | County |
| | Details of Candidates, | Hash Of Off Chain |
| | Open Positions, and | Ballot Template |
| | Ballot Initiatives | Registrar |
| | Date Issued | Time Stamp |
| | Registrar ID | Validity From-To |
| | | Candidate Name |
| | | Candidate Address |
| Ballot 405 | Voter Tokenized ID | Hash (VoterID) |
| | ElectionID | ElectionID |
| | State | Token |
| | County | Status = 1 |
| | Votes | Hash Of Submitted |
| | Submission Time | Ballot |
| | Signature | Signature |
| Accumulator 209 | N/A | Election |
| | | Position |
| | | Candidate |
| | | Count |
| VSO 201 | Unique User | Unique User |
| | Identifier | Identifier |
| | Absentee Request | Status (Ballot |
| | Name | Request Or Voted) |
| | Address (Permanent) | Reference to Off |
| | Address (Current) | Chain Record |
| | Voting Jurisdiction | Hash of Absentee |
| | Requested | Request Application |
| | (State/County) | |
| | Contact Information | |
| | Telephone | |
| | Email | |
| | Absentee Voting | |
| | Request Date | |
| Vault 153 | Hash (VoterID) | N/A |
| | Token (encrypted) | |
| | Election (Token | |
| | Valid For) | |
| | Token-Expiry | |
| Tabulator 406 | N/A | AddressFrom |
| | | (Voter Address) |
| | | AddressTo |
| | | (Candidate Address) |
| | | Value = 1 |

As described elsewhere, in some embodiments, voters 303, election registrar 304, and notary 305 can interact with blockchain access layer 101 through the use of user interface 131. In some embodiments, this user interface takes the form of a mobile app for use with a mobile phone, tablet, or similar device. In some embodiments, the user interface can also take the form of a website or other similar service accessed from a personal computer. In some embodiments, the app or website can take multiple forms based upon who is using the app. In some embodiments, the app or website can allow a voter to register for elections, query what elections the voter signed up for, scan the ballot, submit the ballot, query submitted the submitted ballot, and query and compare the submitted ballot with the ballot that was received by mail. In some embodiments, the app or website can allow an election registrar to create an election, create a ballot, and view election results. In some embodiments, there is a login screen that is the same for both election registrars and voters.

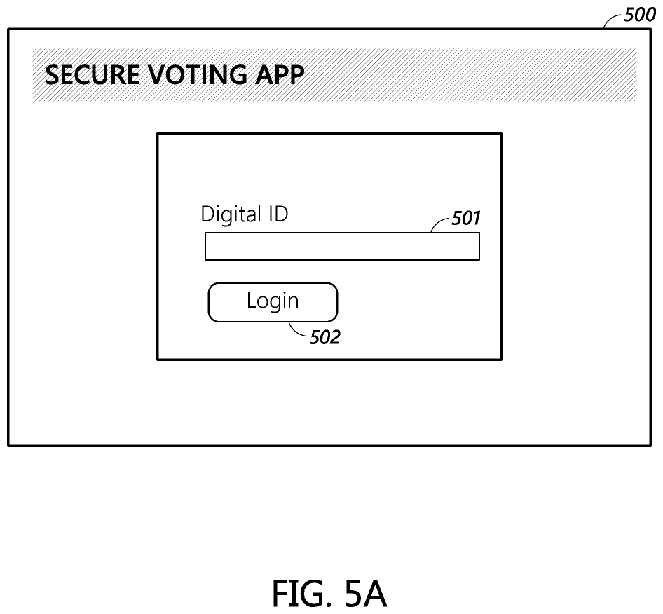

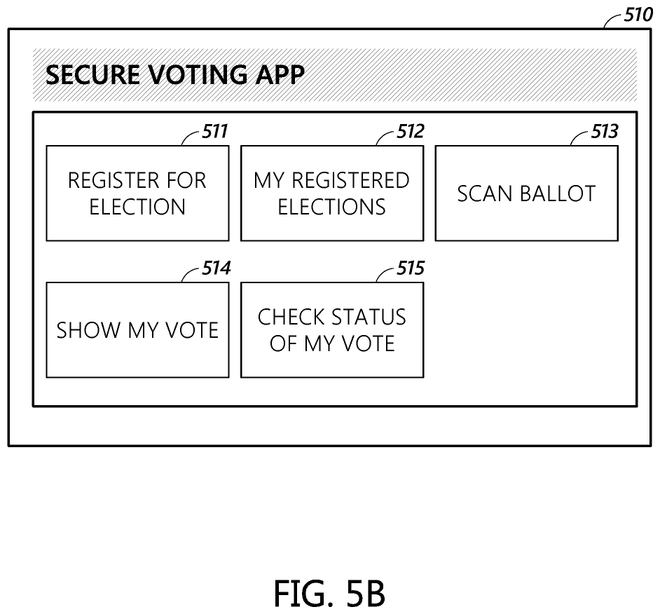

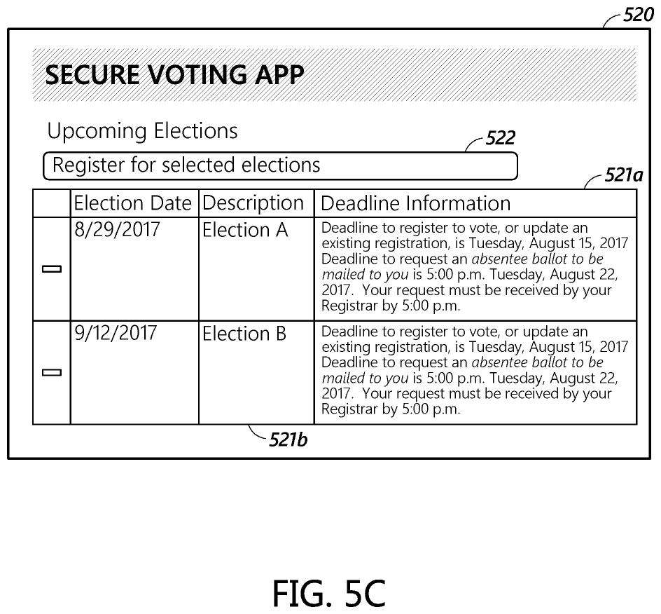

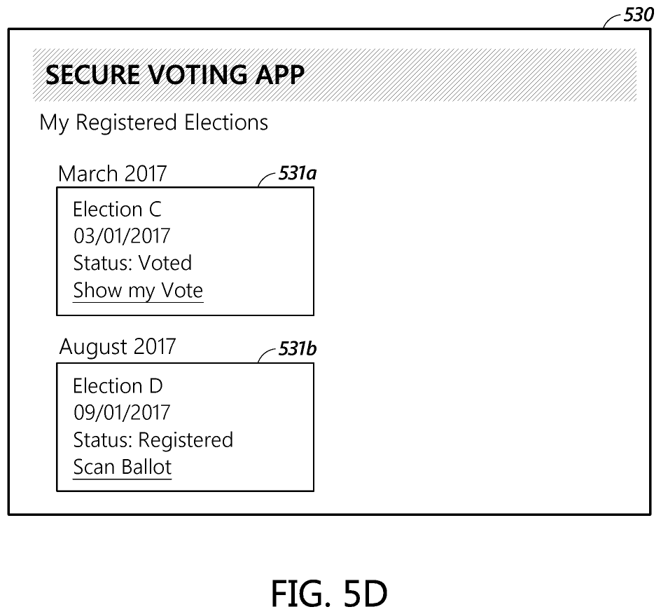

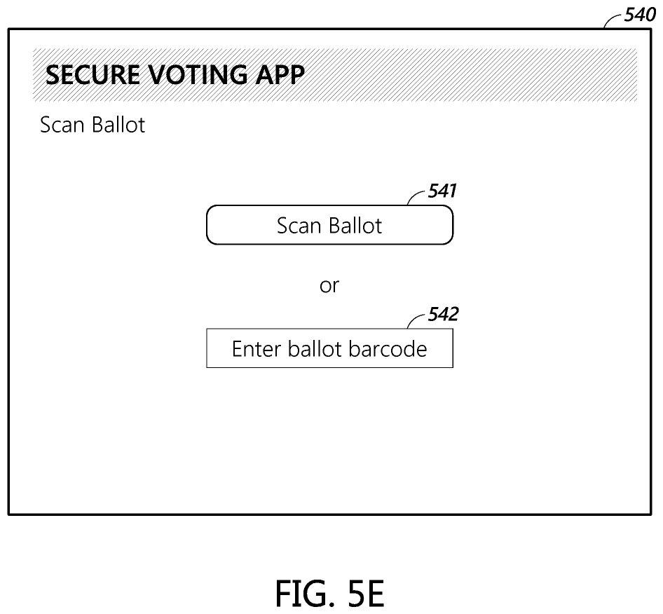

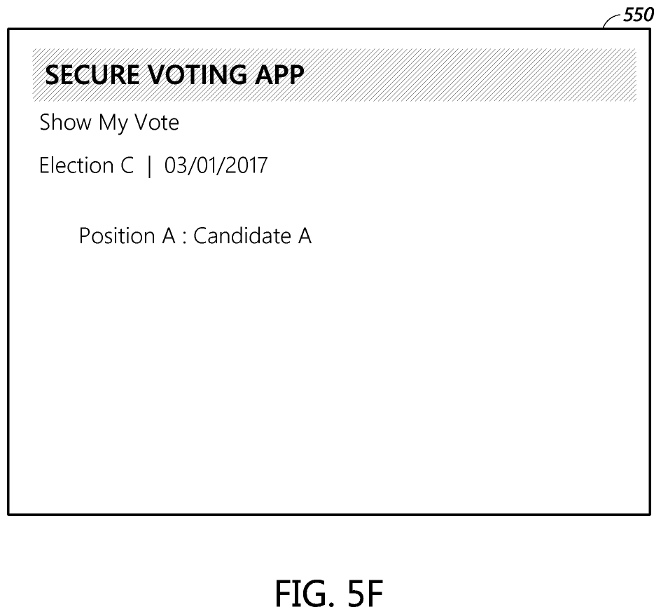

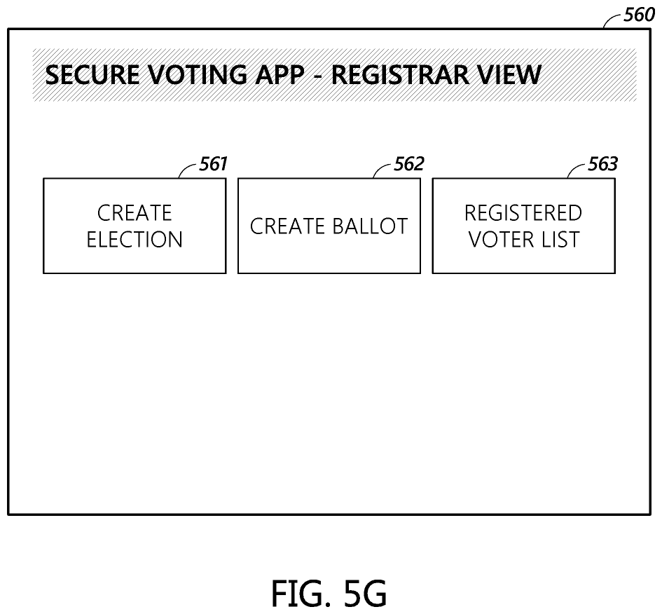

FIG. 5a displays one embodiment of a log in screen for a mobile voting app or website. FIG. 5 displays log in screen 500, which contains a field 501 for entering a digital ID and a virtual button 502 for logging into the system. In some embodiments, the digital ID is generated by the blockchain powered voting system 100 as described further below. To log in to the system the user can input their digital ID and then click or tap on virtual button 502. In some embodiments, once the digital ID has been submitted, the app or website then requests a password from the user. The password can be hashed and then sent, along with the digital ID, to identity management services database 151 to validate the credentials. In some embodiments, the app or website may also use two factor authentication by sending a code to an email address or phone number associated with the digital ID. The voter then keys the received code into the app or website.

FIG. 5b displays an embodiment of the main screen of the voting app as would be seen by a voter logging into the mobile app or website. As shown in FIG. 5b, the main screen can contain a variety of virtual functions that can be used to access various parts of user interface 131. For example, the user can register for elections with virtual button 511, display the elections the voters is registered for with virtual button 512, scan a ballot that has been cast with virtual button 513, show the votes that have been cast with virtual button 514, and check the status of a voters votes with virtual button 515. In some embodiments, the scanning function can use a camera in a mobile computing device

FIG. 5c displays an embodiment of a screen that can be used to register for various elections. As seen in FIG. 5c, screen 520 displays various elections (521a and 521b) that the voter can register for. In some embodiments, the voter can register for an election by checking the check marks in the displayed elections 521a and 521b and then click or tap virtual button 522 to register for the elections that are selected with the check marks. In some embodiments, the elections that the voter selects are recorded on the blockchain along with the voter ID. In some embodiments, the elections that are displayed are retrieved by the website or app using oracles 141 form the appropriate election database 144. Further, when the voter registers for an election, an event is sent back to the county database that provided the oracle election info and then the database can update itself.

FIG. 5d shows another screen of an embodiment of the voting app or website. Screen 530 can display the elections (531a and 531b) that a user is already registered for.

FIG. 5e shows another screen of an embodiment of the voting app or website. FIG. 5e displays screen 540, which allows voters to scan ballots or otherwise enter ballots. In some embodiments, as discussed further below, voters can entered their completed ballots into the system by scanning their ballot. In some embodiments, the ballots can be scanned using the camera of a mobile computing device or by a scanner attached to a personal computer. The system can then identify what ballot is being submitted by looking at the scanned ballot barcode or other computer or machine readable identifier, as discussed further below. In some embodiments, users begin the scanning process by clicking or tapping on virtual button 541. In other embodiments, users enter their votes into the system by submitting a ballot barcode or other computer or machine readable identifier to the system through the use of the numeric code associated with the barcode or other computer or machine readable identifier. The users can enter this code into field 542 and then manually enter their votes into the system using a separate screen (not shown).

FIG. 5f shows another screen of an embodiment of the voting app or website. In screen 550, the voting app or website displays the various votes entered into the system by the voter though scanning their ballot.

FIG. 5g displays another screen of an embodiment of the voting app or website. Screen 560 displays a view of the main screen of the voting app or website as seen by the county registrar or other election management authority that creates and manages elections. In some embodiments, screen 560 has a virtual button 561 that allows the county registrar or other election management authority to enter another screen (not shown) to create an election. In some embodiments, screen 560 has a virtual button 562 that allows the county registrar or other election management authority to enter another screen (not shown) to create ballot for an election. In some embodiments, screen 560 has a virtual button 563 that allows the county registrar or other election management authority to enter another screen (not shown) that displays a list of registered voters.

In some embodiments, the various software modules and objects discussed above can be used to manage numerous functions of the blockchain powered vote by mail system. In some embodiments, the system operates in the following manner. An election official creates a template ballot. A voter applies to vote absentee, and his or her identity is verified and approved by the system. Then, a ballot is generated for the voter with an attached identifier like a QR code, barcode, or other computer or machine readable identifier that obscures the identification information of the voter. In some embodiments, the identifier can be an electronic postmark. In some cases, this is done by hashing the voter information. The ballot is then mailed to the voter, who casts his or her votes, records the votes onto the blockchain via the app or website and optionally mails the ballot back. The election officials can tally the vote using the electronic or paper ballot received from the voter.

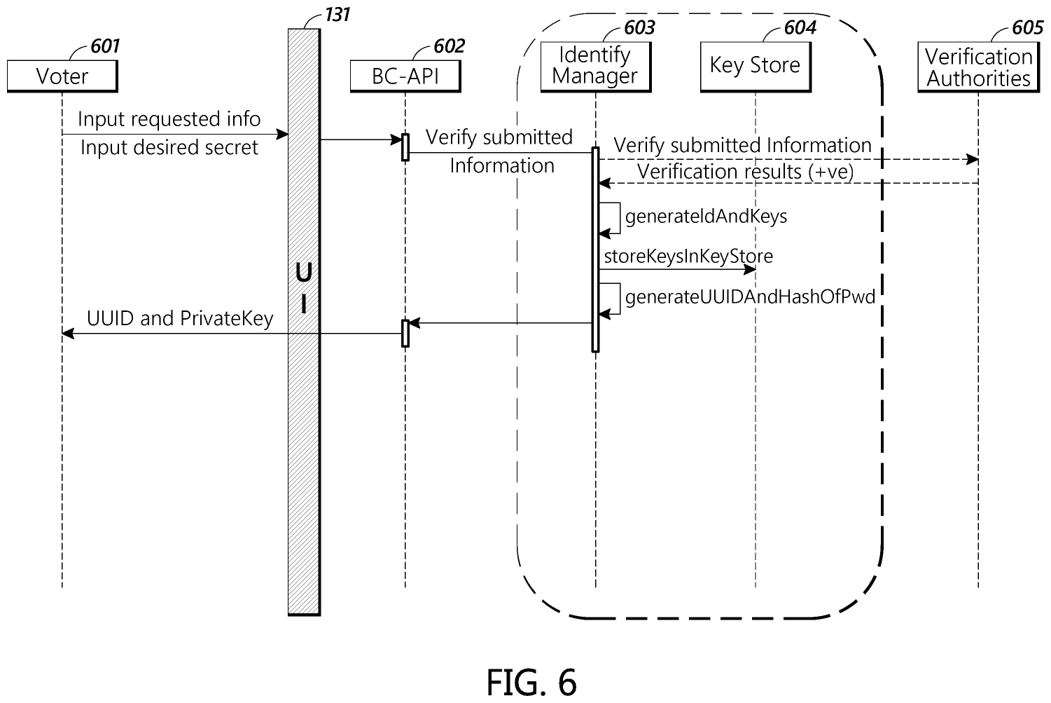

FIGS. 6-13 depict various data flow diagrams of some exemplary operations in various embodiments of the vote by mail system.

FIG. 6 displays a message flow diagram demonstrating an embodiment of how a voter could register with the blockchain powered voting system 100. Voter 601 inputs a desired user name, password, and/or other information into user interface 131. Voter 601 can also include a “secret,” for example the answer to a security question, such as the name of first pet that can also be used to identify the voter. In some embodiments, voter 601 can also input information necessary to verify the identity of the voter, such as a driver's license number, social security number, or address.

User interface 131 sends that information to the blockchain API 602, which then forwards the information on to identity manager 603. Identity manager 603 can then request that verification authorities 605 verify the identity of voter 601. In some embodiments, verification authorities 605 are government entities such as the Social Security Administration, state motor vehicle departments, the Federal Bureau of Investigation, and the United States Postal Service that can use the submitted information to verify the identity of voter 601. In some embodiments, the blockchain API 602, the identity manager 603, and other components of the system can be a part of or embodied in the blockchain access layer 101 or other component of the systems described herein.

Once verification authorities 605 have verified the identity of voter 601, the verification authorities send the results to identity manger 603. If verification authorities 605 confirm the identity of the voter 601, identity manager 603 will generate a unique user identifier (UUID) for the voter 601 and create a public/private key pair for the voter 601. The public/private key pair will later be used to sign transactions on the blockchain. Once the keys have been generated, identity manger 603 sends the keys for storage into key store 604. In some embodiments, key store 604 can also store the user IDs and secrets of voters, as well as digital tokens that can be used to identify voters instead of user names and secrets. Finally, identity manager 603 generates a UUID and a hash of the user's password and sends the information to the blockchain API 602. Blockchain API 602 then sends the unique user identifier and private key back to the voter 601.

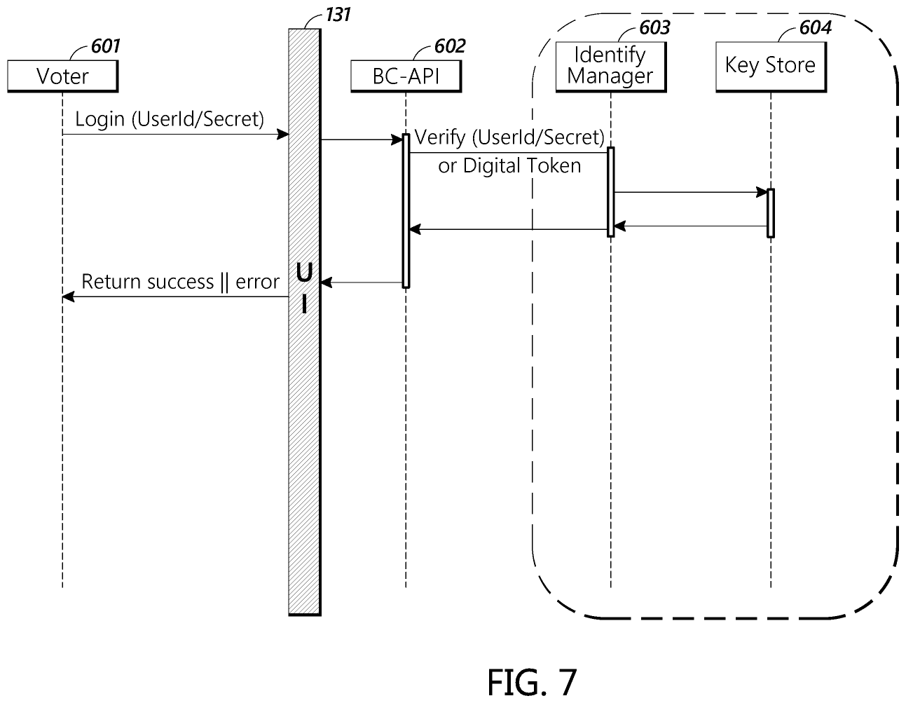

FIG. 7 depicts a message flow diagram demonstrating an embodiment of how a voter could log on to the voting systems of the current disclosure. In some embodiments, voter 601 will log in to the system by submitting his or her UUID, password, and secret to the user interface 131, which will then forward it on to blockchain API 602. In some embodiments, blockchain API 602 then requests that identity manager 603 verifies the user ID and secret. In some embodiments, the identity manager 603 then verifies the user ID secret or token with key store 604, which then responds back with the results to identity manger 603, which then forwards the results to blockchain API 602. Blockchain API 602 then returns a success or error message back the voter 601.

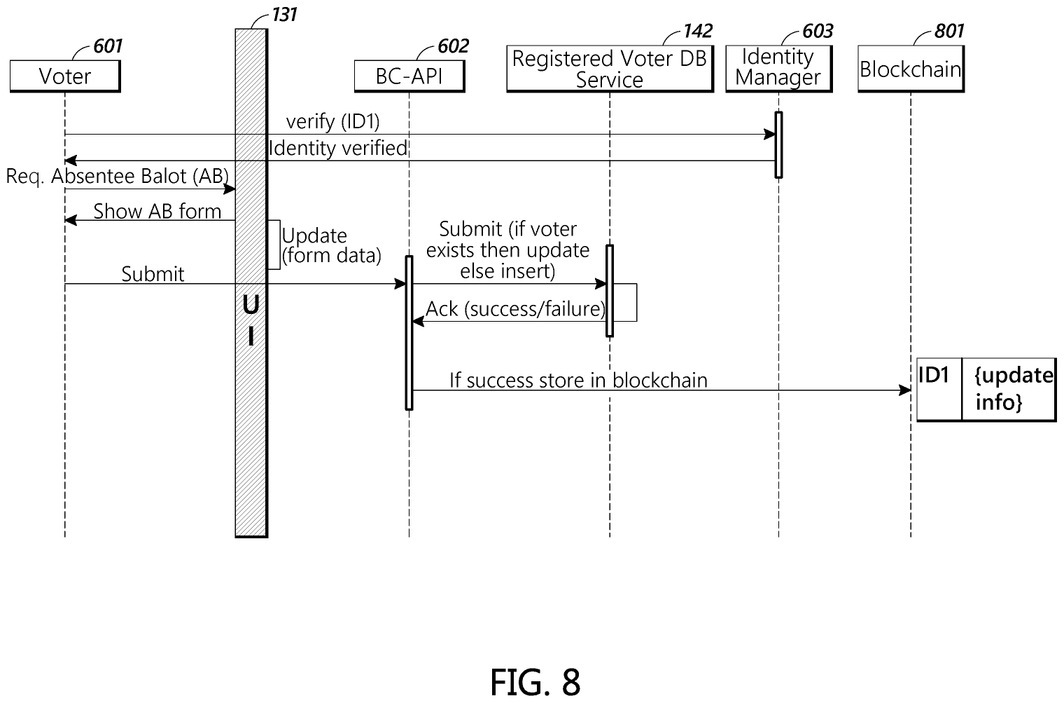

FIG. 8 depicts a message flow diagram demonstrating an embodiment of how a voter can request and fill out an ballot with the system. First the voter 601 submits its specific identification number, e.g. ID1, to the identity manager 603 and has its identity verified by identity manager 603 in the manner previously described. The voter 601 then requests an ballot from user interface 131, which then returns the ballot. The voter then fills out/updates the ballot using user interface 131 before submitting the ballot to blockchain API 602. Blockchain API 602 then confirms that the voter exists within the registered voter database service 142 and receives a success or failure message back. If the attempt at confirmation is successful, the blockchain API then stores the submitted ballot onto the blockchain. In some embodiments, the blockchain API stores the submitted ballot on to the blockchain by updating the information associated with the specific voter ID, e.g. ID1. In some embodiments, the voter-ballot database 154 can also determine if multiple votes were received from a particular voter and note this on the blockchain as well. The voter-ballot database 154 can then determine whether actions should be taken to deal with the multiple votes, such as marking the voter for a fraud review or determining which of the votes to count.

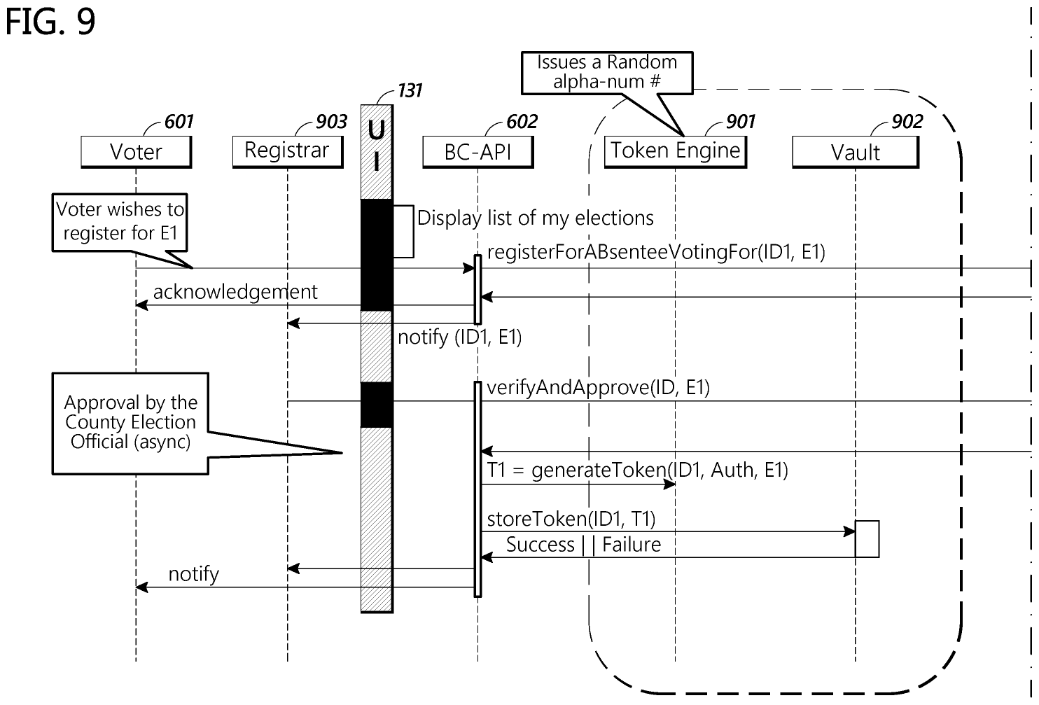

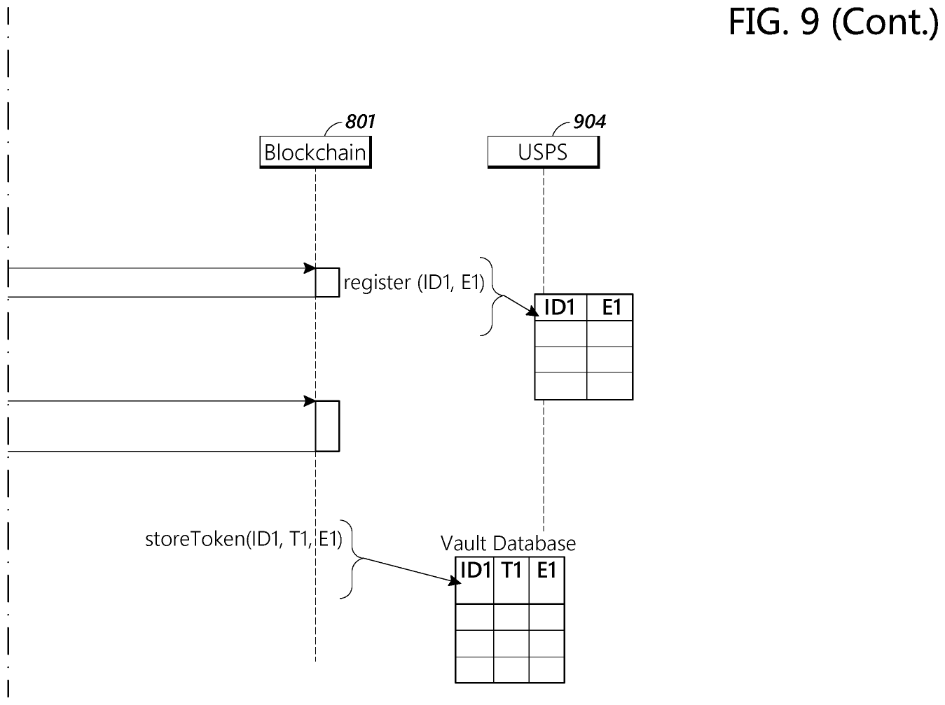

FIG. 9 depicts a message flow diagram demonstrating how a voter can request to register for an election. First, user interface 131 displays a list of elections for voter 601. Voter 601 then submits a request to register for an ballot to blockchain API 602 through user interface 131. In some embodiments, this request contains a specific user ID (ID1) and a unique alphanumeric election ID (E1). The blockchain API 602 then registers the voter's request to blockchain 801. In some embodiments, the blockchain API 602 registers the user ID and election ID to the blockchain 801. In some embodiments, blockchain API 602 also transmits the user ID and election ID to the United States Postal Service 904 or other entity that will eventually be responsible for mailing the physical ballot. Next, blockchain 801 sends acknowledgement back to blockchain API 602 which forwards it on to voter 601 through user interface 131. Blockchain API 602 then notifies registrar 903 that the voter 601 has registered for an election. In some embodiments, this notification contains the user ID and election ID. Next, registrar 903 then informs the blockchain API 602 that the user is verified and approved for the election through user interface 131. In some embodiments, this message includes the relevant user ID and election ID. The blockchain API 602 then stores this approval onto blockchain API 602. Blockchain API 602 then generates a token for the voter 601. In some embodiments, the token is generated by the user ID, authorization, and election ID. In some embodiments, the blockchain API 602 generates the token in conjunction with a random alphanumeric sequence issued by token engine 901. The blockchain API 602 stores the association between the token (T1), the user id (ID 1), and the election id (E1) in vault 902, such as a vault database 153 or similar structure. In some embodiments, the blockchain API 602 sends the information to the United States Postal Service 904 or other entity that will eventually be responsible for mailing the physical ballot. In some embodiments, the United States Postal Service 904 or other entity can use this information to generate a barcode, EPM®, or other computer or machine readable identifier that will be printed on the paper ballot that will allow the user to later scan the ballot. In some embodiments, the barcode or other computer or machine readable identifier is based on a hash of the election ID and user ID. Vault 902 returns a success/failure message to user blockchain API 602. Finally, blockchain API 602 notifies voter 601 and registrar 903 that the registration has occurred.

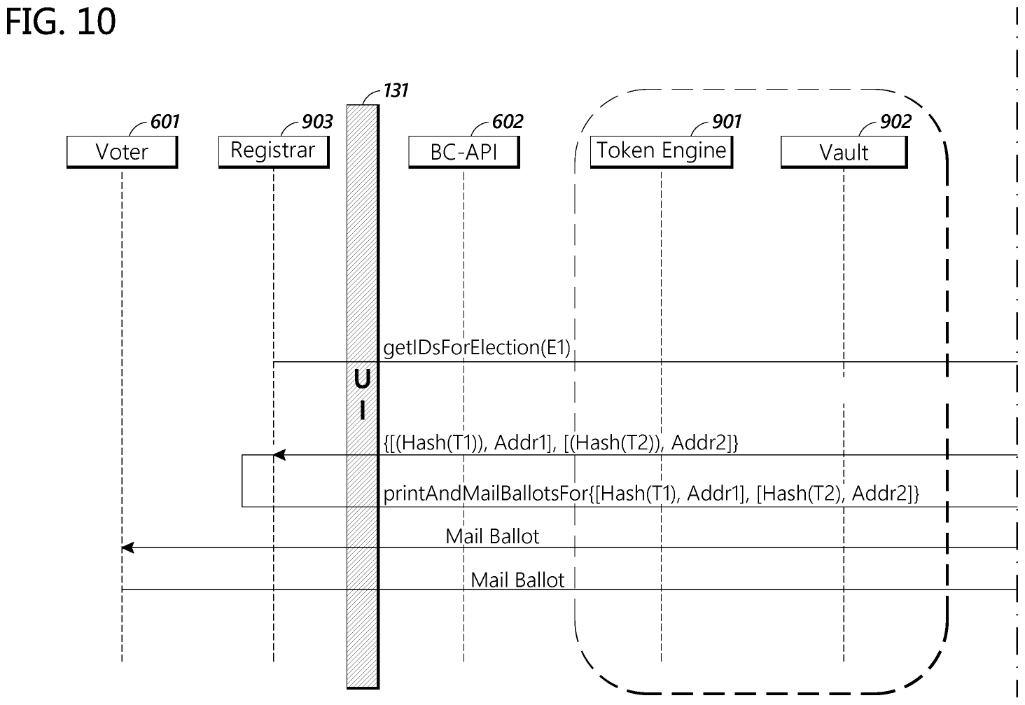

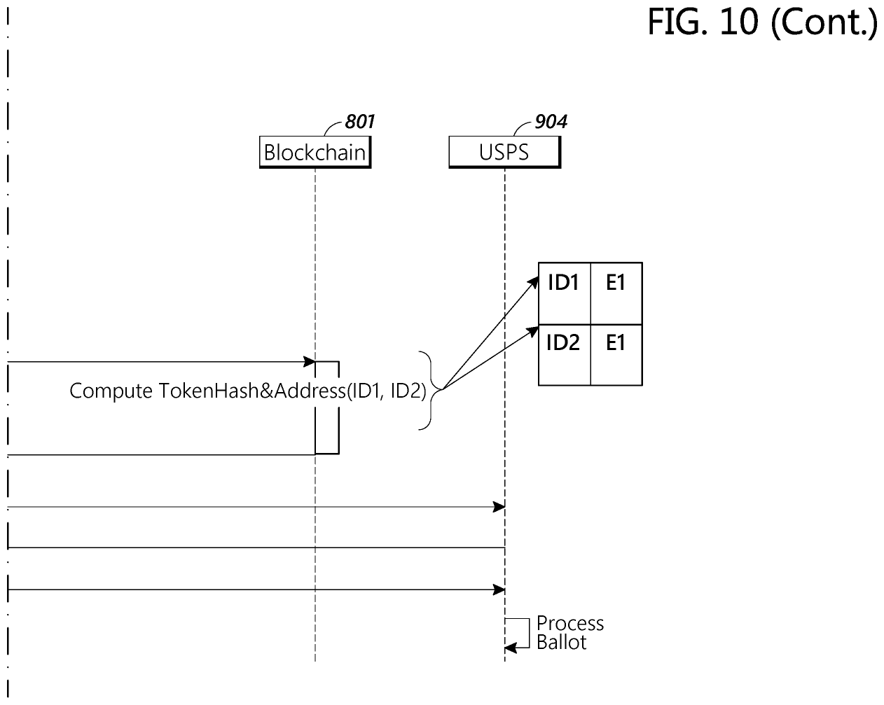

FIG. 10 is a message flow diagram demonstrating how the United States Postal Service or other mailing entity can mail ballots. In some embodiments, the registrar 903 requests the all of the user IDs registered for a particular an election ID from blockchain 801. The blockchain 801 responds with a hash of each token associated with the user and the address of the user. Registrar 903 then requests that the United States Postal Service 904 or other entity print the ballots based on the hashed tokens and addresses. In some embodiments, United States Postal Service 904 or other entity can then mail the ballots to the voter 601. In some embodiments, the United States Postal Service 904 or other entity can notify the voter 601 when the ballot is placed in the mail and where the ballot is in the mail system as the ballot is mailed.

In some embodiments, the voter 601 can then receive the ballot from the postal service, fill out the ballot, and mail it back through USPS 904. In some embodiments, USPS 904 can then use mail ballot processor 134 to read the barcodes or other computer or machine readable identifier attached to the physical ballots and determine if the mailed ballot was received in time for the votes to count in the election based on the time that the machine readable identifier was scanned by a mail processing system. In some embodiments, the mail ballot processor 134 can also be used to determine which entity should count a particular received ballot based on the machine readable identifier. For example, the mail ballot processor could determine that a particular county or state counting office was responsible for counting the ballot. The ballot can then be mailed on to the appropriate entity for counting.

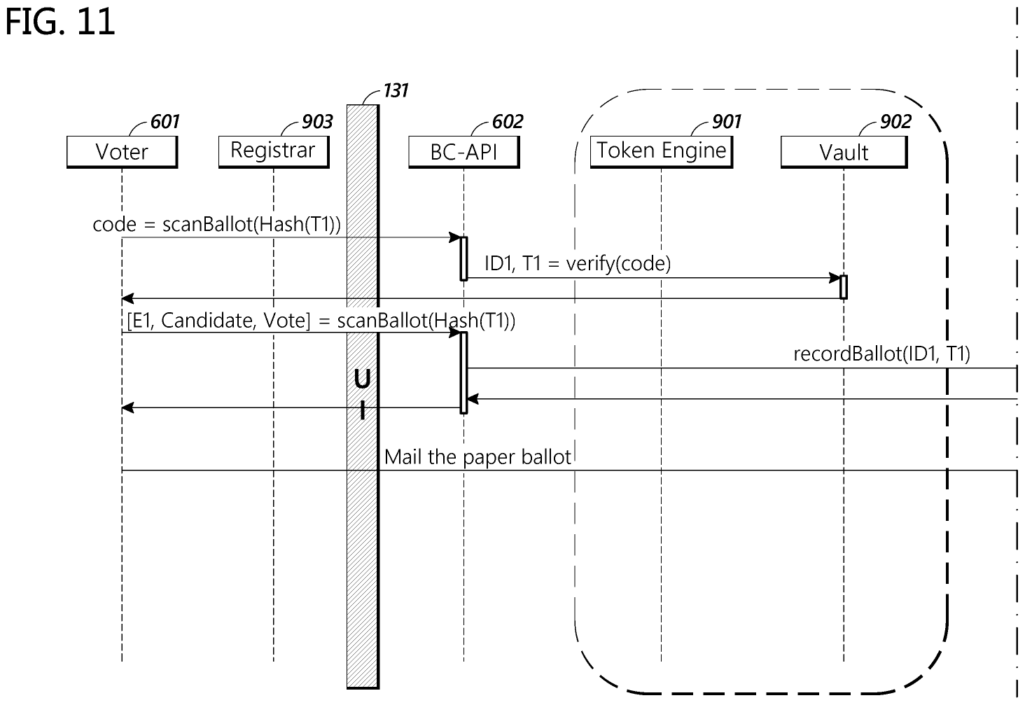

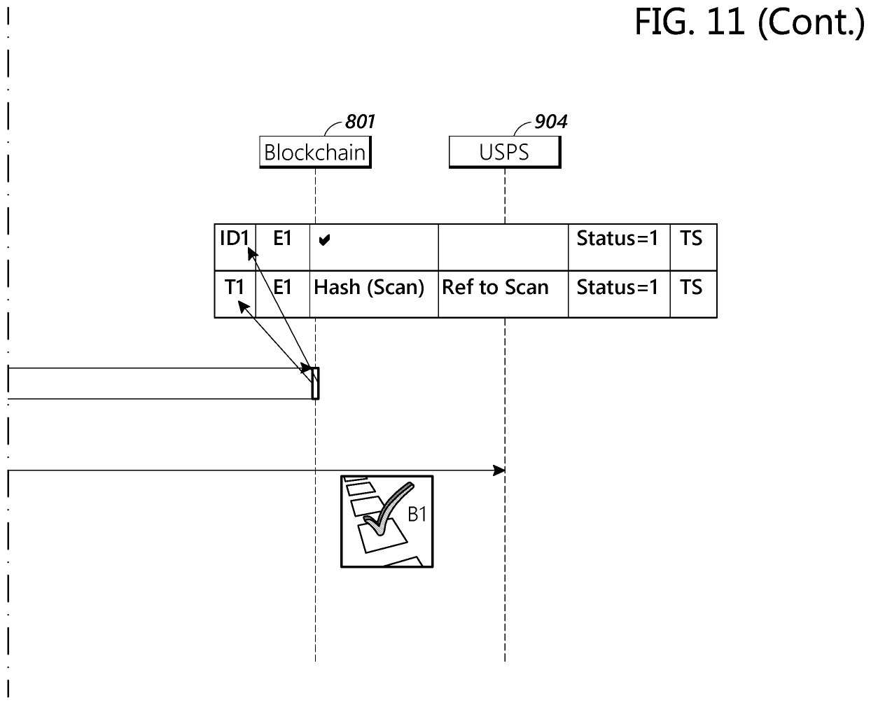

FIG. 11 shows a message flow diagram for how a voter can receive a mailed ballot and then submits and mails the ballot. When the ballot is mailed, mail processing equipment can scan a computer readable code on the ballot. The mail processing equipment or connected network systems can identify the code as being associated with a ballot, and, in some embodiments, with a geographic area or with a particular voter. The mail system can update the status of the ballot with the system, can provide an expected delivery date for the ballot to the voter, track the ballot, etc. When the ballot is delivered to the voter, the carrier can scan the ballot when it is delivered, or the system can identify the out for delivery scan as a delivery. The postal service can gather the information from the ballots and the associated scans on mail processing equipment and/or by carriers, and provide reports to election officials regarding where, when, how many, and other statistics regarding the ballot delivery.

In some embodiments, the postal service can update a ballot record with a delivered status. When the voter returns the ballot via the mail, when the computer readable code is scanned on the mail processing equipment, the system can check to determine whether this code has been used before, as would be the case when the ballot was delivered, and can determine that the scanned ballot is a completed ballot, or that the ballet is being returned to the election official. Reports can be generated and provided to the election official with this information.

The ballot is First, the voter 601 scans the barcode or other computer or machine readable identifier on the mailed ballot. In some embodiments, the barcode or other computer or machine readable identifier is formed based on a previously generated hash of the token (T1) and user ID (ID1) and is applied to the physical ballot. In some embodiments, the scan information is sent to blockchain API 602 which verifies this scanned barcode or other computer or machine readable identifier with vault 902 by comparing scanned codes with stored voterID, T1, E1, or other stored information. In some embodiments, these steps are accomplished by having voter 601 manually complete the paper ballot. Then voter 601 logs on to user interface 131 using user ID as previously discussed and chooses a “Scan Code” option on the user interface 131 to scan the barcode or other computer or machine readable identifier on the mailed ballot. The barcode or other computer or machine readable identifier is passed to the vault 902 which can compare it to hashes of previously stored tokens.

The voter 601 can then scan the individual votes on the ballot and submit them to blockchain API 602. This can be done by voting in an application or a mobile computing device, by taking a picture of a filled out physical ballot and returning the image, etc. Blockchain API 602 can record the ballot on blockchain 801. In some embodiments, voter 601 performs the scan through user interface 131. User interface 131 can use a process choices feature to accumulate the scanned choices and, in some embodiments, confirm their accuracy by checking with ballot database 152. The choices can be stored in a “voter ballot” internal database in user interface 131 until they are ready to be submitted. Once the voter 601 wants to submit the ballot, the user interface will use the “Submit Ballot” feature to fetch the relationship between the voter ID and the token. The ballot choices are saved in the voter-ballot off-chain database 154 along with voter ID, ballot barcode or other computer or machine readable identifier, hash of the digitally stored ballot, and timestamp. Then the voter ID, token, ballot hash, reference to the ballot in the voter-ballot database 154 and time stamp are recorded on the blockchain 801. Finally, blockchain 801 can send a success message back to voter 601 through blockchain API 601 and the voter can mail the paper ballot to the United States Postal Service 904 or other entity. In some embodiments, the selections are not input until the mailed ballot is received.

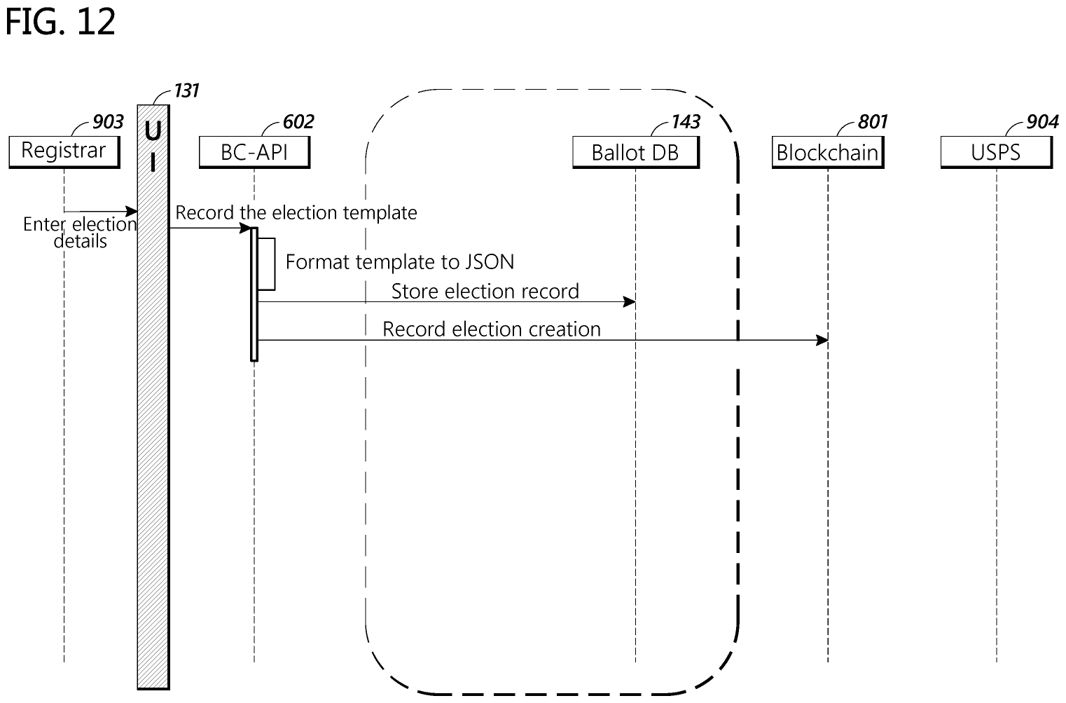

FIG. 12 depicts a message flow diagram showing how a registrar can create an election template. First Registrar 603 enters the election details into user interface 131. User interface 131 then records the election template blockchain API 602. In some embodiments, the blockchain API 602 can reformat the election template into the JSON format. The blockchain API then stores the election record into ballot database 142 and records the election creation on blockchain 801.

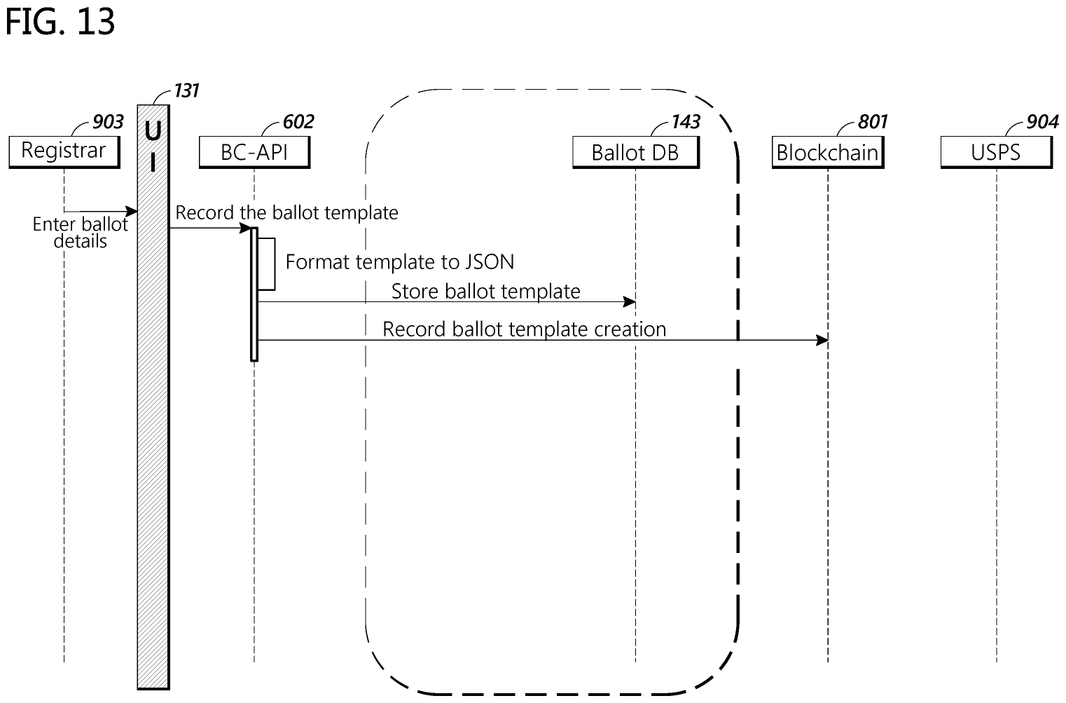

FIG. 13 depicts a message flow diagram showing an embodiment of how a registrar can create a ballot template. First Registrar 603 enters the ballot details into user interface 131. User interface 131 then records the ballot template blockchain API 602. In some embodiments, the blockchain API 602 can reformat the ballot template into the JSON format. The blockchain API then stores the ballot template into ballot database 142 and records the ballot template creation on blockchain 801.

In some embodiments, some parts of the system can also be used to create a secure voting procedure using secure electronic identity labels for in person voting. In some embodiments, potential voters can visit their state's official voting registration for voting; or call to request official documentation be mailed to the nearest state's USA Voter Registration center in the state that the voter currently resides in, or county's USA Embassy. The voters can then have their identity validated at the approved polling registration station for in-person validation and photo taken for submission prior to receiving special form. If the voter is not in the particular state the voter can call the state's USA Voter Registration Center in the state or country the voter is located in. In some embodiments, this process can be handle in whole or in part by identity services 130.

In some embodiments, as the voter's identity is being verified, the verification information can be transmitted through voter registry 142 to system 100. The EPM 132 can then generate a particular electronic barcode associated with that voter. In some embodiments, the EPM 132 can also generate special coding identifiers, such as bar codes, that represent identifying information about the voter, such as state, voter ID, issuer, voter residence, voter mailing address, age, sex, birth, education level, etc. In some embodiments, the special coding identifiers and electronic barcode are then printed on a special form used as part of the verification process. These forms can also be electronically signed and dated by the system and the state issuing the form.

Once the voter's identification has been verified, the voter can then go to the polls where, a polling worker can confirm the voter's identity. The poll worker can then issue a special electronic postmarked stamped voting card. The voting card can be taken to the polling machine, where it is inserted. The voting machine only allows people with a voting card to vote and will only allow a person with a particular electronic postmark to vote once. Once the vote has been cast, the voting machine can issue a receipt containing there voting information. The vote can then be stored on the blockchain. In some embodiments, the vote can also be stored in a local server, main tallying server and an archive server. Further, the voting cards themselves are stored by the machine as a physical record of who voted.

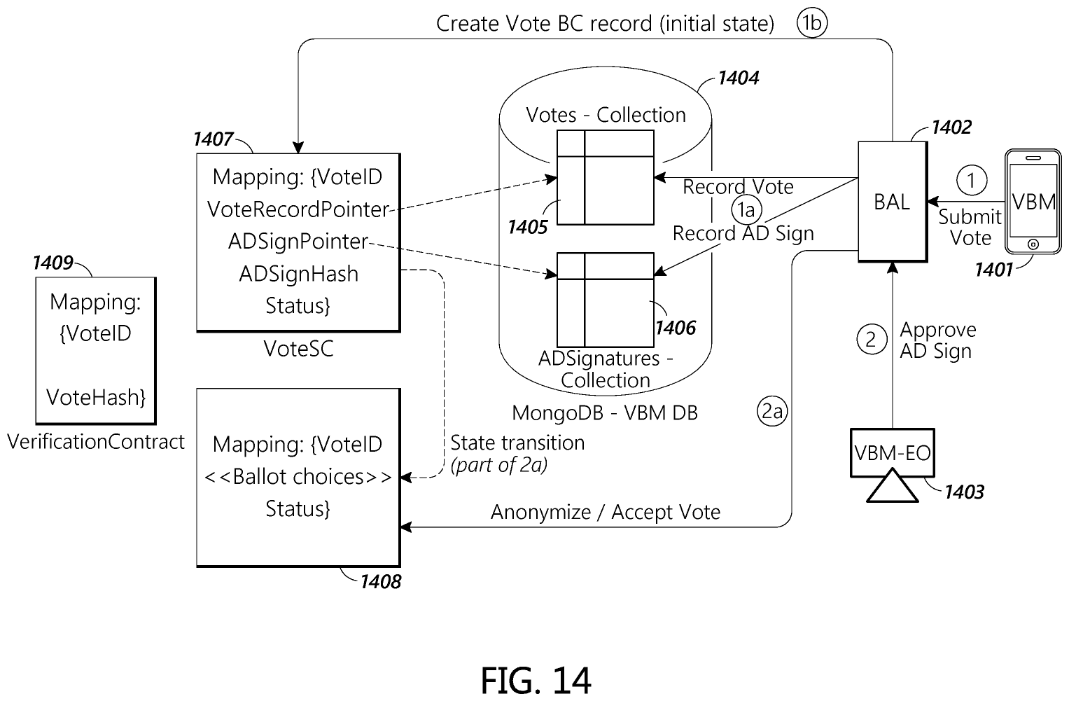

FIG. 14 displays an embodiment of a system 1400 for securely storing votes on a blockchain. In some embodiments, this system can be combined with any and all features of all systems described herein in order to create a secure voting system. In some embodiments, a voter can interact with an application 1401 on a tablet, mobile phone, personal computer, or other computing device. In some embodiments, the application 1401 can correspond to or be similar to the user interface 131 of FIG. 1. In some embodiments, the application can be known as a “Vote By Mail” application or “VBM” application. In some embodiments, a voter must first register to vote with the appropriate election authority in order to download the VBM application. This registration can include a voter signature, such as an image of a voter's electronically captured hand-written signature, for the election official to store and use to authenticate ballots and voters. The signature object can be a bitmap created within the VBM application. Once the voter has registered with the appropriate election authority, the voter can then receive authorization that allows them download and install the application. In some embodiments, this authorization can be a ballot access token. A voter can receive a ballot access token from the VBM application or from the system. In some embodiments, the ballot access token is included on a physical document that is mailed to the specific voter. The ballot access token allows a voter to access his or her ballot that is stored in the database. Ballot access tokens are assigned individually to each voter. In some embodiments, the ballot access token can be a 12 character alphanumeric string and special characters. The ballot access token can be a QR code or other computer readable code which allows the voter to access the ballot on the VBM application when scanned. In some embodiments, the ballot access token can only be used one time in an election. In some embodiments, the user can scan this code with a computing device, and then download the application 1401.

In some embodiments, once the application 1401 has been downloaded, the user can then receive a second bar code, QR code, or some other computer readable code that allows a user to vote in a specific election. The second code can be sent on a physical document to the user, such as a verification document sent in by the mail. In some embodiments, the user can scan the physical code on the mailed document with the application 1401, which can operate the camera or scanner of a mobile computing device running the application 1401. The scanned code will authorize access to the VBM application for a specific ballot and/or election based on the voter identity stored in or associated with the scanned code. The application 1401 will load into the application 1401 the ballot of the election that the user is registered or authorized to vote in. This can be determined based on the voter's address. For example, in a single election, a voter may vote for different offices or candidates based on where the voter lives. The ballot that is presented to the voter will correspond to the ballot the voter is authorized to vote on. In some embodiments, the code can also contain a BallotID, and ElectionID, and a VoterID. The VoterID is a unique identifier that designates the voter. The BallotID and ElectionID are identifiers for the election that reference a ballot and election within the system that user will vote in and the ballot that the user will vote with.

Once the ballot has been loaded into the application 1401, the user can then fill out the ballot to vote in the election. In some embodiments, the user can also use the application to “sign” the ballot by using a stylus or finger to record a digitized version of the user's physical signature. Once the ballot has been filled out, the application 1401 transmits the votes or ballot selections to a blockchain abstraction layer or blockchain access layer (BAL) 1402, or to other parts of the system. In some embodiment, the application 1401 transmits the ElectionID, BallotID, VoterID as well as the ballot selections the user made on the ballot to other parts of the system. In some embodiments, the application 1401 can also transmit the digitized version of the user's physical signature. All of this information is transmitted to blockchain access layer 1402.

In some embodiments the blockchain abstraction layer 1402 can be a computer, server, database or computing device or group of computing devices that coordinate storing information on the blockchain. In some embodiments blockchain abstraction layer 1402 can correspond to or be similar to the blockchain access layer 101 in FIG. 1. In some embodiments, the blockchain abstraction layer 1402 can receive information from application 1402 and then coordinate storing that information and creating entries for that application on the blockchain.

In some embodiments, the blockchain abstraction layer 1402 can store information in voting databases 1404. In some embodiment voting databases 140 can correspond to some or all of databases 150 from FIG. 1. In some embodiments voting databases 1404 can comprise two separate databases votes database 1405 and signature database 1406. In some embodiments, the blockchain access layer sends data about the actual votes that the user submitted to votes database 1405 and submits data about the identity of the user including the digitized signature and VoterID to signature database 1406 (shown as 1a on FIG. 14). Separating the storage of the identity of the voter from the votes case helps to ensure that the votes are anonymous. In some embodiments, the data in both voting databases can be encrypted through the use of an unbound key pair stored in in a unbound key pair cache or database. In some embodiments, the unbound key pair cache or databases stores multiple keys in separate key modules and then encrypts the data using each portion of the key in each module. In some embodiments, this can be two or three modules. This increases security by requiring that an attacker compromise all the modules in order to decrypt the data. In some embodiments, the unbound key pair cache or database can correspond to key store 604.

In some embodiments, the blockchain abstraction layer 1402 can also create an entry on the submitted vote blockchain 1407 as it creates the entries in the voting databases 140 (shown as 1b on FIG. 14). The blockchain abstraction layer 1402 records, on the submitted vote blockchain 1407 to stores information about the voting. In some embodiments, for each ballot submitted, the blockchain abstraction layer 1402 creates a voteID, a unique entry on the submitted vote blockchain 1407 that contains a unique number that corresponds to the cast ballot or an instance of the vote or of a receipt of ballot selections, and a pointer that points to the vote record stored in the votes database 1405, a pointer that points to the data in the signature database 1406, a hash of the digitized signature of the voter, and a count of all of the votes currently submitted.

Once the data has been stored in the voting databases 1404, and the above data has been written to the submitted vote blockchain 1407 the blockchain abstraction layer 1402 can also transmit the signature data to a vote by mail election official application 1403. The application 1403 can be used by an election official to verify that the correct voter casts the votes. In some embodiments, this can be done by comparing the digitized signature in the signature data with the signature on file when the voter registered to vote. An election official can perform this comparison to validate a voter and to approve the casting of votes by the voter. The election official uses application 1403 to inform the blockchain abstraction layer 1402 that the vote is approved (shown as 2 on FIG. 14).

In some embodiments, once the voter is approved, the blockchain abstraction layer 1402 creates an entry on accepted vote blockchain 1408. The accepted vote blockchain 1408 can be stored in blockchain database, or as part of a blockchain distributed ledger, or on another desired blockchain architecture. In some embodiments, accepted vote blockchain 1408 contains the VoteID, and includes the actual ballot choices for the vote, and the tabulation of all the votes currently casted in the election. In some embodiments, once this entry is created on the accepted vote blockchain 1408 all links between the actual votes cast and the affidavit or identity of the voter casting the votes are deleted.

In some embodiments, the votes can also be verified using verification contract database 1409 as discussed more below.

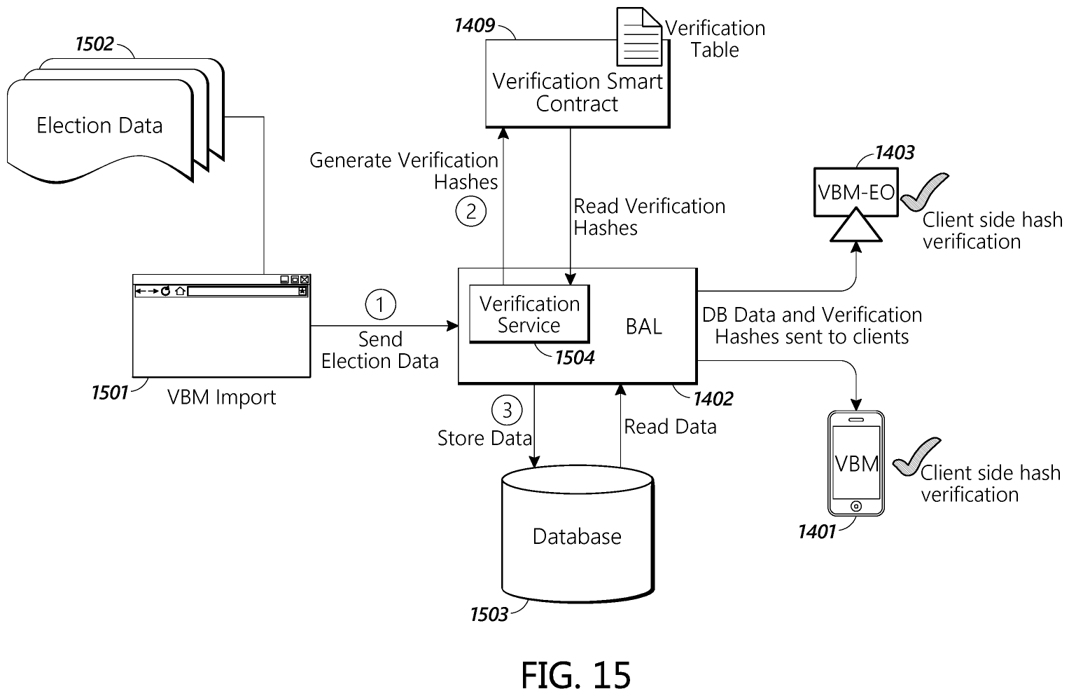

FIG. 15 displays one embodiment of a system that can be used to verify data sent out of the secure voting system using a verification smart contract. The system of verifications described herein provides auditability and a strong reporting mechanism. In some embodiments, this system can be combined with any and all features of the systems described elsewhere herein in order to create a secure voting system. In some embodiments, the system comprises a vote by mail import application 1501. Vote by mail import application 1501 is an application that is used to transmit or import election data 1502 into the blockchain abstraction layer 1402. In some embodiments, election data can be any data that is transmitted to blockchain abstraction layer 1402 from any other part of the system, including information creating or establishing the ballot, any vote data sent by the VBM application 1401, or any data sent by election official application 1403.

In some embodiments, when the blockchain access layer 1401 receives election data 1502, the blockchain abstraction layer 1402 can use the verification service module 1504 to create a hash of the data that was transmitted. In some embodiments, the verification service module 1504 can be part of the blockchain abstraction layer 1402. In other embodiments, the verification service module 1504 can be a separate component. This hash is then stored on the verification contract database 1409 as part of a blockchain. In some embodiments, the hash can also be transmitted to neutral third party location to provide an additional level of security for the system. At the same time, the blockchain abstraction layer 1402 stores the data in the database 1503. In some embodiments, the data is stored in any of the databases 150 described above or in the voting databases 1404, or any other database that the blockchain abstraction layer 1402 can use to store data.

In some embodiments, when any client device, such as applications 1401 and 1403, then reads data from blockchain abstraction layer 1402, the blockchain abstraction layer 1402 can read the data from the database 1503 and also retrieve the hash from verification contract database 1409 and transmit the data to the client device. Then the client device can calculate its own hash of the transmitted data and compare it the hash of the data it received to determine if the data has been altered. If the calculated hash and the received hash do not match, a flag or error can be generated to indicate that data has been altered, corrupted, tampered with, or can identify another problem.

In some embodiment, the hash comparison can occur whenever data is retrieved by the system. In other embodiments, the system will only calculate and compare hashes at certain checkpoints. These checkpoints can occur at the following points: data ingestion, when the election data is ingested; Ballot storage, when ballot contents are stored to ensure they are unchanged from when they were received; ballot presentment to voter, such as checking the validity or integrity of the ballot before it is provided to the voter; vote submission, when the votes are submitted; vote tabulation, when the votes are counted to ensure that only votes that have not been tampered with are counted; vote metrics, to ensure that the auditability metrics are secure. For example, the system can periodically check the hash of the ballot information to ensure that the ballot contents did not get changed. This could happen daily or weekly for example. In some embodiments, when the ballot is presented to the voter through application 1401 the application can check the verification hash against the application computed hash of the ballot before presenting to the voter. The hash of the ballot presented to the voter could also be reported by the mobile app for validation by an independent auditor. The hash of the ballot and the hash of the voter choices could also be calculated and stored at the time of vote submission by the voter from their application 1401. A screenshot from the device for each of the voter's choice could also be recorded and stored anonymously with a ‘weak link,’ e.g. an unbound key pair, to the cast vote. This will allow any auditor a visual aid for comparing and verifying the vote that was cast. Additionally, at the time of vote tabulation, hash verification can be required to ensure that only untampered ballots are being included in the extract.

The auditability features and metrics can analyze, compare, and/or include the numbers of: votes cast, broken down by each choice; rejected votes, broken down by each choice; the number of votes waiting for signature verification, broken down by each choice; accepted votes, broken down by each choice; abandoned attempts and disruptive errors; and questions answered. This data can be used after an election for tracking an accuracy of the vote information extracted from the voting application to the voting jurisdiction's tabulation process. The data can also provide useful information to the election official during the election.

For Ballot security, the intended ballot gets presented and voted upon as finalized by the election office or election official. The success factors for ballot security can include: ballots being stored within the system and a verification has computed and stored on the blockchain; a periodic audit of the most current ballot contents an the verification hash stored by an external verifier; and an application attempting to display the accurate ballot or an auditor wishing to validate the integrity of the ballot can simply compare the verification hash on the ballot and compare it to the has of the presented ballots on the voters' devices.

A ballot presentment check can include retrieving verification hashes independently from any of the 3rd party locations and compared against the hash computed on the ballot that the application is about to present. In case of any difference between the hashes, the app can signal a possible variance in the ballot content integrity. An auditor can compare the hashes of the possible ballot styles and sample the hashes of ballots presented to voters from various precincts and find a match. Any instance of incorrect ballot presentment instances can be identified and flagged.

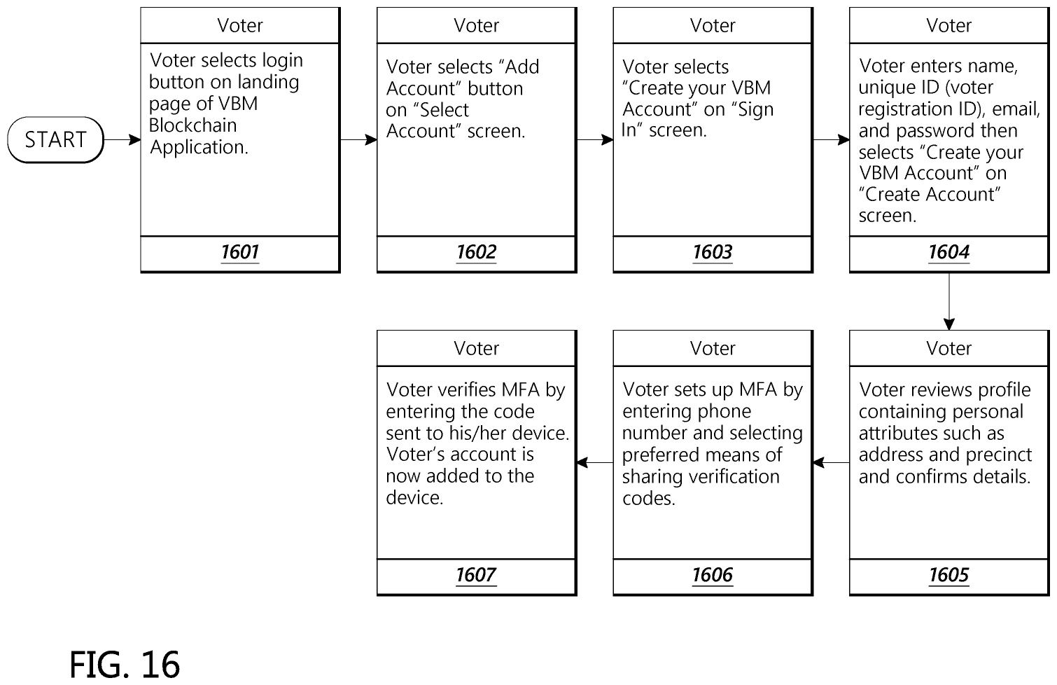

FIG. 16 displays a flow chart demonstrating one embodiment of how a user can create an account to use the secure voting system. The flow chart starts with process block 1601. In process block 1601 a voter selects login button on the landing page of the VBM blockchain application. In some embodiments, this VBM blockchain application can be application 1401. The process then proceeds to process block 1602.

In process block 1602, the voter selects an “add account” button on a select account screen in the VBM blockchain application. The process the proceeds to process block 1603.

In process block 1603, the voter selects a create VBM account button on the sign in screen in the VBM blockchain application. The process then proceeds to process block 1604.

In process block 1604, the voter enters his name, unique ID (voter registration ID), email, and password then selects a create your VBM account button on the create account screen on the VB blockchain application. The process then proceeds to process block 1705.

In process block 1605, the voter reviews a personal attributes such as address and precinct details and then confirms those details with the VB blockchain application. The process then proceeds to process block 1606.

In process block 1606, the voter sets up multi-factor authentication by entering a phone number and selecting preferred means of sharing verification codes using the VB blockchain application. The process then proceeds to process block 1607.

In process block 1607, the voter verifies the multi-factor authentication by entering the code sent to his or her device using the VB blockchain application. The voter's account is now added to the device.

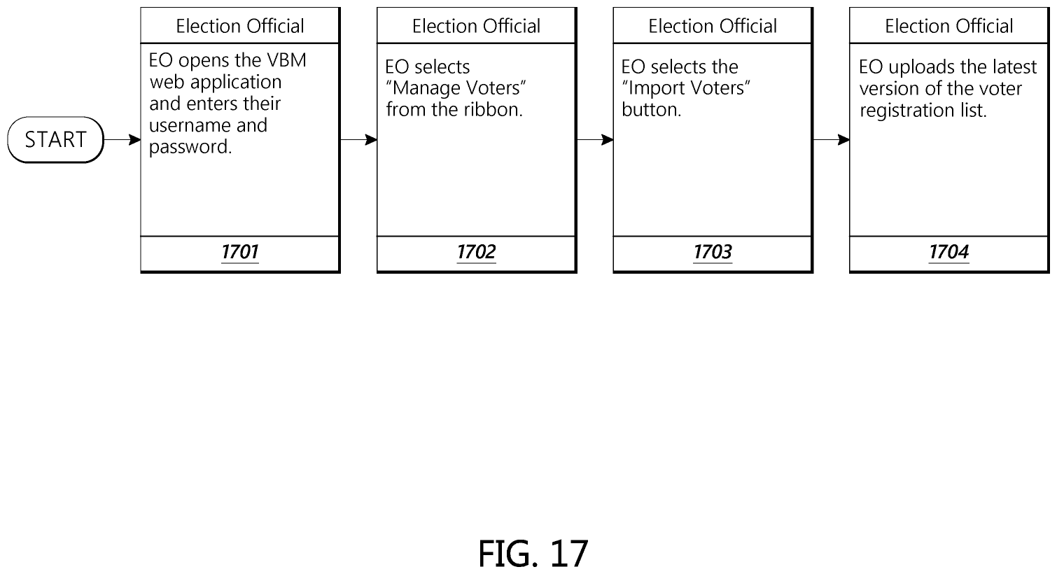

FIG. 17 displays a flow chart demonstrating one embodiment of how an election official can load a list of voters that can use the system. The process starts with process block 1701. In process block 1701, an election official opens up a VBM web application and enters their username and password. In some embodiments, the VBM web application can be the vote by mail election official application 1403. The process the proceeds to process block 1702.

In process block 1702, the election official selects the manage voters button from the ribbon in the VBM web application. The process then proceeds to process block 1703.

In the process block 1703, the election official selects the import voters button in the VBM web application. The process then proceeds to process block 1704.

In process block 1704, the election official uploads the latest excel version of the voter registration list or other data file contain the voter registration list into the VBM web application.

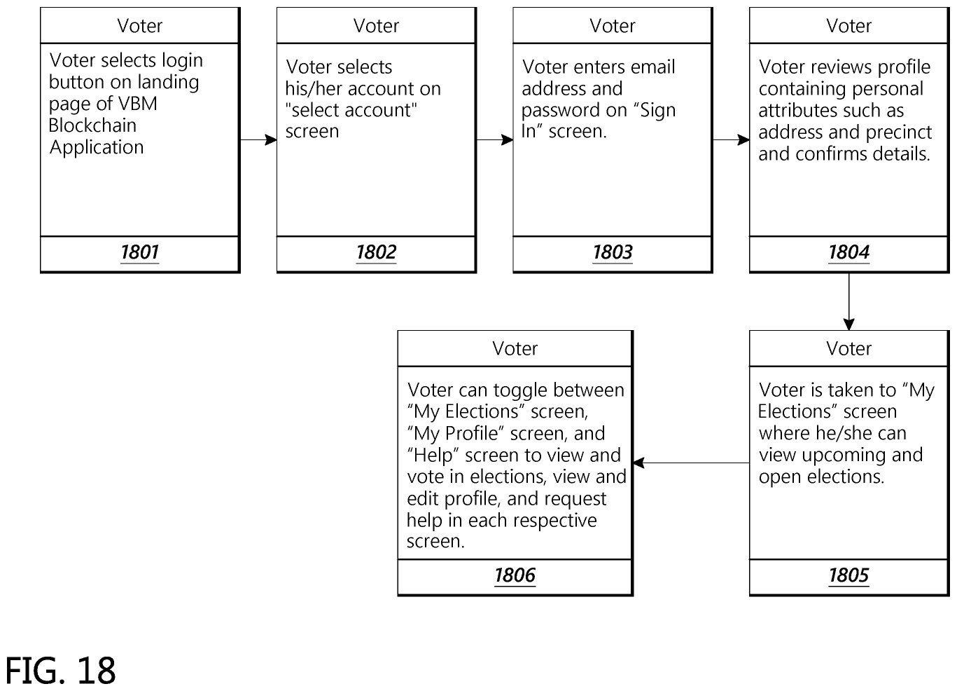

FIG. 18 displays a flow chart demonstrating one embodiment of how a user can log in to an account to use the secure voting system. The process begins with process block 1801. In process block 1801, the user selects the login button on the landing page of the VBM blockchain application. In some embodiments, the blockchain application can be application 1401. The process then proceeds to process block 1802.

In process block 1802, the voter selects his/her account on the select account screen of the VBM blockchain application. The process then proceeds to process block 1803.

In process block 1803, the voter enters his or her email address and password on the sign in screen on the VBM blockchain application. The process then proceeds to process block 1804.

In process block 1804, the voter reviews the voter's profile containing personal attributes such as address and precinct and confirms details using the VBM blockchain application. The process then proceeds to process block 1805.

In process block 1805, the voter is taken to the my elections screen on the VBM blockchain application where he/she can view upcoming and open elections. The process then proceeds to process block 1806.

In process block 1806, the voter cam toggle between a my election screen, a my profile screen, and a help screen to view and vote in elections, view and edit profile, and request help in each respective screen using the VBM blockchain application.

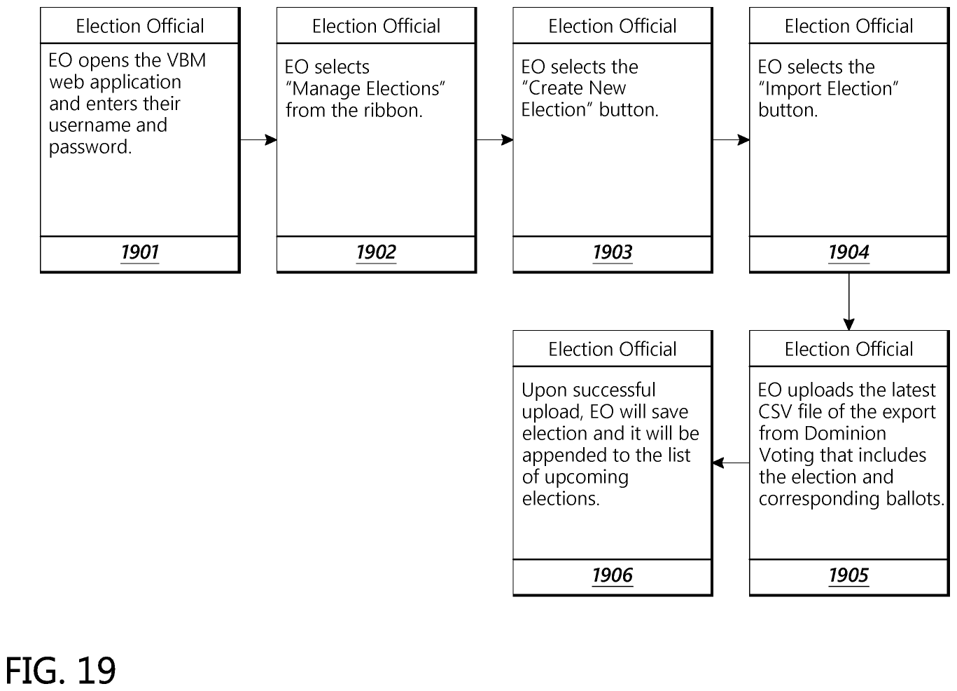

FIG. 19 displays a flow chart demonstrating one embodiment of how a election official could create a new election for use with the secure voting system. The process starts in process block 1901. In process block 1901, the election official opens the VBM web application and enters their username and password. In some embodiments, the VBM web application can be the vote by mail election official application 1403. The process then proceeds to process block 1902.

In process block 1902, the election official selects the manage elections button from the ribbon on the VBM web application. The process then proceeds to process block 1903.

In process block 1903, the election official selects a create new election button on the VBM web application. The process then proceeds to process block 1904.

In process block 1904, the election official selects the import election button on the VBM web application. The process then proceeds to process block 1905.

In process block 1905, the election official uploads the latest CSV file or other data file that includes the election and corresponding ballots. The process then proceeds to process block 1906.

In process block 1906, when the election is successfully upload, the election official can save the election and it will be added to the list of the upcoming elections.

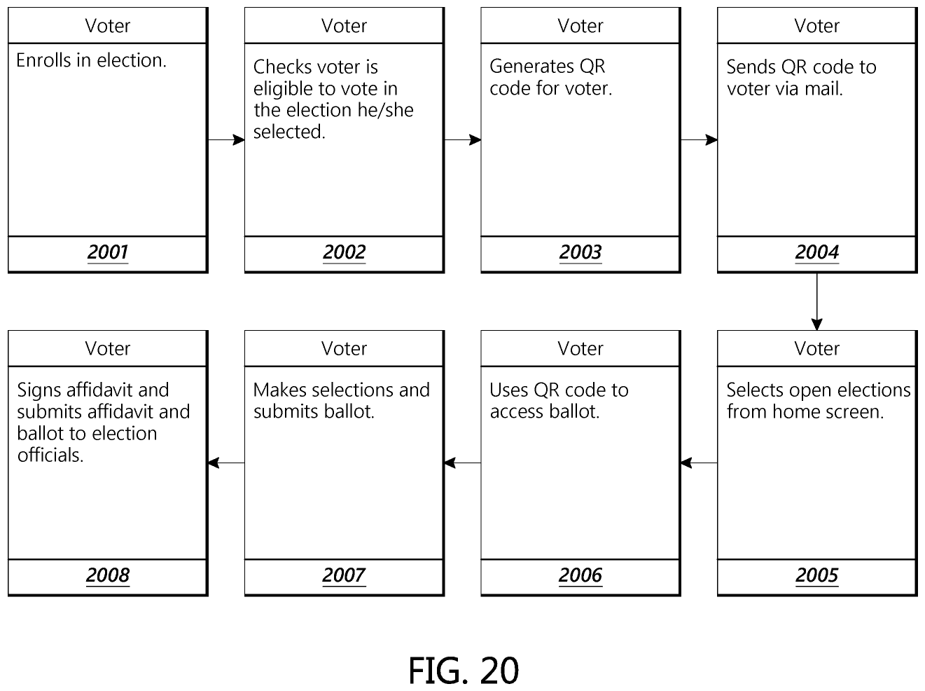

FIG. 20 displays a flow chart demonstrating one embodiment about how a ballot can be presented to the voter and then cast by the voter using the secure voting system. The process begins with the process block 2001. In process block 2001, the voter enrolls in a particular election using the VBM blockchain application. In some embodiments, this VBM blockchain application can be application 1401. The process then proceeds to process block 2002.

In process block 2002, the secure voting system confirms that the voter is eligible to vote in the election he or she selected. In some embodiments, this can be confirmed by the blockchain access layer 101 or 1401 using voter registry 142. The process then proceeds to process block 2003

In process block 2003, a QR code generates a QR code for the voter. The process then proceeds to process block 2004.

In process block 2004, an election official send the QR code to the voter via mail. The process then proceeds to process block 2005.

In process block 2005, the voter then opens the elections from the home screen of the VBM blockchain application. The process then proceeds to process block 2006.

In process block 2006, the voter scan the QR code using the VBM blockchain application. This gives the voter access to the ballot for the election. The process then proceeds to process block 2007.

In process block 2007, the voter uses the VBM blockchain application to make selections on the ballot. The process then proceeds to process block 2008.

In process block 2008, the voter signs the affidavit and submits the affidavit and ballot to the election official using the VBM blockchain application. In some embodiments, the voter signs the affidavit using a stylus or finger to create a digitized version of the user's signature.

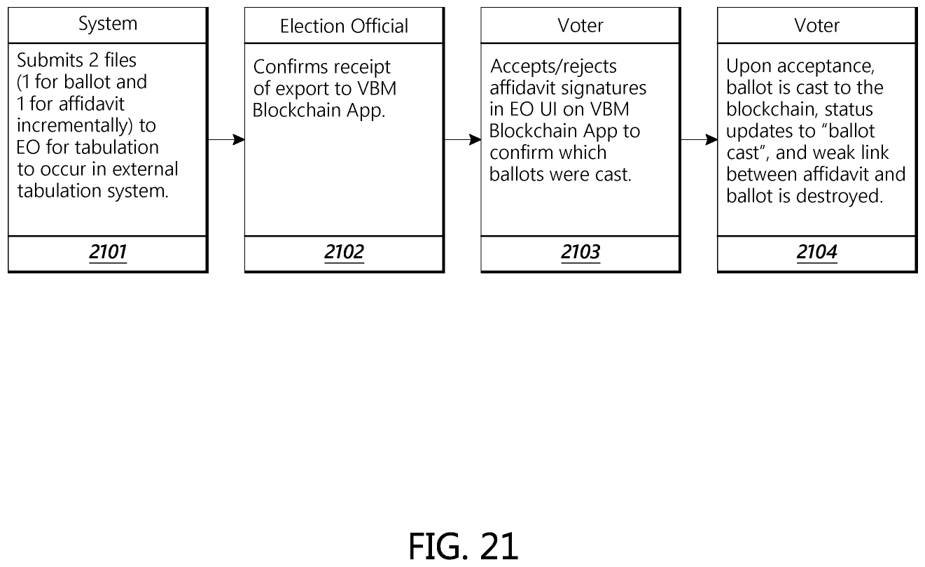

FIG. 21 displays a flow chart demonstrating one embodiment of how the votes can be tabulated using the secure voting system. The process begins with process block 2101. In process block 2101, the system submits the ballot and affidavit file to the election official for tabulation to occur. In some embodiments, the ballot access layer 1402 or 101 submits sends this information to election official application 1403 from voting databases 1404. The process then proceeds to process block 2102.

In process block 2102, the election official confirms receipt of the two files using the VBM web application. In some embodiments, the VBM web application can be the vote by mail election official application 1403. The process then process to process block 2103.

In process block 2103, the election official accepts or rejects the affidavit using the VBM web application to confirm that the ballot was appropriately cast. The election official can send this information to the ballot access layer 101 or 1401. The process then proceeds to process block 2104.

In process block 2104, the ballot is recorded on the blockchain by the blockchain access layer 101 or 1401 and the link between the affidavit and ballot is destroyed.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware. A person of skill in the art will understand that the functions and operations of the electrical, electronic, and computer components described herein can be carried out automatically according to interactions between components without the need for user interaction.

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

What is claimed is:

1. A voting system comprising:
a blockchain access layer configured to:
receive input from a user operated mobile computing device, the input comprising a computer readable code scanned from a physical ballot, ballot selections, and an electronic signature; and
receive input from an election official system, the input comprising a ballot and an election identifier;
a first database in communication with the block chain access layer, the first database configured to receive and store the ballot selections and the electronic signature from the blockchain access layer;
a second database in communication with the block chain access layer, the second database configured to:
receive a vote identification from the blockchain access layer, the vote identification generated by the blockchain access layer in response to receive the ballot selections and electronic signature from the mobile computing device;
store a first pointer to a location of the ballot selections in the first database; and
store a second pointer to a location of the electronic signature in the first database; and
a blockchain database configured to receive the vote identification from the second database and to receive the ballot selections from the blockchain access layer, wherein the block chain database receives the vote identification and the ballot selections when the block chain access layer receives an electronic signature confirmation from the election official system.

2. The voting system of claim 1, wherein the ballot selections and the electronic signatures are stored in separate structures in the first database.

3. The voting system of claim 2, wherein the first database has no referential data associating the ballot selections with the electronic signatures stored in the separate structures in the first database.

4. The voting system of claim 1, wherein the vote identification is a random alphanumeric string for tracking the instance of a vote.

5. The voting system of claim 1, wherein the electronic signature is an object bitmap created within a voting application on the user operated mobile computing device.

6. The voting system of claim 1, wherein the election identifier identifies a particular election.

7. The voting system of claim 1, wherein the blockchain access layer is further configured to receive a voter identification from the user operated mobile computing device, the voter identification identifying a unique user registered with the election official system.

8. The voting system of claim 1, further comprising a verification contract database, and wherein the blockchain access layer comprises a verification service module, wherein the verification service module is configured generate a hash of the ballot selections and the electronic signature received in the blockchain access layer, and to send the hash of the ballot selections and the electronic signature to the verification contract database.

9. The voting system of claim 8, wherein the blockchain access layer is further configured to send the hash of the ballot selections and the electronic signature to the user operated mobile computing device or to the election official system.

10. The voting system of claim 1, wherein the computer readable code includes at least one of a ballot identifier, an election identifier, and a voter identifier, and wherein the blockchain access layer authorizes the mobile computing device access to an electronic ballot based on the ballot identifier, election identifier, or the voter identifier.

11. A voting method comprising:
receiving, in a blockchain access layer, input from a user operated mobile computing device, the input comprising a computer readable code scanned from a physical ballot, ballot selections, and an electronic signature;
receiving input from an election official system, the input comprising a ballot and an election identifier;
receiving, in a first database, the ballot selections and the electronic signature from the blockchain access layer;
receiving, in a second database, a vote identification from the blockchain access layer, the vote identification generated by the blockchain access layer in response to receiving the ballot selections and electronic signature from the mobile computing device;
storing, in the second database, a first pointer pointing to a location of the ballot selections in the first database;
storing, in the second database, a second pointer pointing to a location of the electronic signature in the first database; and
receiving, from the election official system, confirmation of the electronic signature;
transmitting, to a blockchain database, the vote identification from the second database and the ballot selections corresponding to the vote identification based on the first pointer; and
storing, in the blockchain database, the ballot selections.

12. The voting method of claim 11, wherein storing the ballot selections and the electronic signatures in the first database comprises storing the ballot selections and the electronic signature in separate structures in the first database.

13. The voting method of claim 12, wherein the first database has no referential data associating the ballot selections with the electronic signatures stored in the separate structures in the first database.

14. The voting method of claim 11, wherein the vote identification is a random alphanumeric string for tracking an instance of the ballot selection.

15. The voting method of claim 11, wherein the electronic signature is an object bitmap created within a voting application on the user operated mobile computing device.

16. The voting method of claim 11, wherein the election identifier identifies a particular election.

17. The voting method of claim 11, the method further comprising, receiving, from the user operated mobile computing device, a voter identification, the voter identification identifying a unique user registered with the election official system.

18. The voting method of claim 11, further comprising generating:
in a verification service module, a hash of the ballot selections and the electronic signature received in the blockchain access layer; and
sending the hash of the ballot selections and the electronic signature to the verification contract database.

19. The voting method of claim 18, further comprising, sending the stored hash of the ballot selections and the electronic signature to the user operated mobile computing device or to the election official system.

20. The voting method of claim 11, further comprising, authorizing, in the blockchain access layer, access to an electronic ballot based on the received computer readable code.
